(19) United States
(12) Patent Application Publication
(10) Pub. No.: US 2012/0057456 A1
(43) Pub. Date: Mar. 8, 2012

(54) METHOD AND APPARATUS FOR DISTRIBUTED COMMUNICATION USING SHORT RANGE AND WIDE RANGE COMMUNICATION LINKS

(75) Inventors: Boris Bogatin, Huntingdon Valley, PA (US); Drew Jacobs, Broomall, PA (US)

(73) Assignee: NEARVERSE, INC., Huntingdon Valley, PA (US)

(21) Appl. No.: 13/264,903

(22) PCT Filed: Apr. 16, 2010
(86) PCT No.: PCT/US2010/031494

§ 371 Date: Oct. 17, 2011

Related U.S. Application Data
(60) Provisional application No. 61/169,972, filed on Apr. 16, 2009.
(60) Provisional application No. 61/169,955, filed on Apr. 16, 2009.

(51) Int. Cl. H04W 28/02; H04W 4/00

(52) U.S. Cl. 370/230.1; 370/328

(57) ABSTRACT

A method and apparatus for a wireless device comprising means for receiving first packets of an IP flow utilizing a wireless link to a cellular base station or a Wi-Fi access point during a first time interval; means for receiving second packets of an IP flow utilizing a wireless link to another wireless device during the first time interval; and means for recovering the IP flow utilizing the first and second packets are disclosed.

### CROSS REFERENCE TO RELATED APPLICATION

This application claims the benefit of U.S. provisional application No. 61/169,972 filed Apr. 16, 2009, and U.S. provisional application No. 61/169,955 filed Apr. 16, 2009 which are incorporated by reference as if fully set forth.

### FIELD OF THE INVENTION

Methods wireless connectivity using a cloud.

### BACKGROUND

Today, devices connect to either 3G networks, and thus to the Internet, or to each other, directly through a single radio-access link. In some case, including through offerings providers like Attila Technologies, FatPipe, ShareBand, and Asankya, providers have combined multiple available RF or wireline network interfaces to be used by a single device to carry out “bonded” traffic delivery, but in all cases using a uniform, end-to-end traffic delivery approach from the client and the servers that interface the “bonded” links. Methods are desired having devices supplemented direct paths with indirect paths, which use end-to-end radio-access links other than the direct primary link, to connect to other intermediate devices or servers, which serve as “intermediaries” or routers/processors that further pass-through traffic flow or processes to the Internet or in-turn to each other.

Methods are desired having multiple RF resource to connect together two nearby devices. In these cases, devices would supplement the single direct links, with multiple RF interfaces, including use of the 3G/Internet networks, or multiple short-range wireless mediums, including Bluetooth, Ad-hoc Wi-Fi, and Infrastructure Wi-Fi, as “bonded” additional links to the direct, independent ad-hoc Wi-Fi and Bluetooth links available between two devices that are nearby.

Methods are desired having nodes acting as “intermediaries” in such a system been asked to serve further “intelligent routing” functions, including also caching the packet flow, multicasting the packet flow, seeding the system of other “intermediaries” with such packet flow for their further function as “intermediaries”, creating a directory of such packet flow available at the intermediaries, and performing other additional functions on the packet flow to improve the system.

### SUMMARY

A method and apparatus for a wireless device comprising means for receiving first packets of an IP flow utilizing a wireless link to a cellular base station or a Wi-Fi access point during a first time interval; means for receiving second packets of an IP flow utilizing a wireless link to another wireless device during the first time interval; and means for recovering the IP flow utilizing the first and second packets are disclosed.

A method and apparatus comprising a server sending data of an IP flow of a first wireless device to a plurality of wireless devices; wherein the entire IP flow is transferred to the first wireless device utilizing the plurality of wireless devices and each of the wireless devices is not sent by the server all the data of the IP flow are disclosed.

### BRIEF DESCRIPTION OF THE DRAWINGS

A more detailed understanding may be had from the following description, given by way of example in conjunction with the accompanying drawings wherein:

FIGS. 1a and 1b are a flow diagram for a method implementing preconditions;

FIG. 2 shows a functional block diagram of a wireless communication environment 200;

FIG. 3 is a block diagram of an enabled device;

FIG. 3b is a block diagram showing Nearverse Protocol Layer Architecture;

FIG. 4 is a diagram of a Networking Layer;

FIGS. 5a and 5b show a method of registration;

FIG. 6 is a flow diagram implementing a method for creating a virtual resource operating system;

FIG. 7 is a block diagram of a VROS within a single NearCloud;

FIG. 8 shows an example system for network management and clearinghouse;

FIG. 9 shows a flow diagram for an optimization process;

FIG. 10 shows an implementation of a base system;

FIG. 11 shows a system for creating a NearCloud, and its implementation using proximate links as shown in FIG. 5;

FIG. 12 is a flow diagram for a method of data delivery;

FIG. 13 shows a flow chart for a method for optimization with data segmentation and network routing;

FIG. 14 is a flow chart for a method of determining reliability factors;

FIG. 15 shows a system for caching of data delivery;

FIG. 16 is a flow diagram for a method of caching;

FIG. 17 shows a system for pseudo multi-casting of data;

FIG. 18 shows a system for intelligent combining of data delivery;

FIG. 19 shows a system for simple NearCloud multicasting of data using Nearclouds at the signal processing layer;

FIG. 20 shows a system for advanced NearCloud multicasting of data using Nearclouds at the signal processing layer; and

FIG. 21 shows a system employing the portable apparatus.

### DETAILED DESCRIPTION

When referred to hereafter, the terminology “link” includes but is not limited to any network or device communication link, resource, process, including any intelligent networking technique, or any other type of digital interaction.

When referred to hereafter, the terminology “wide area communications” includes but is not limited to transmissions using two-way terrestrial wireless networks based on fourth generation (4G) air interfaces such as WiMAX and Third Generation Partnership Project (3GPP) Long Term Evolution (LTE), LTE advanced, third generation (3G) air interfaces such as Evolution Data Optimized (EV-DO) and High speed packet access (HSPA)/High speed downlink packet access (HSDPA)/High speed uplink packet access (HSUPA), second generation (2G) air interfaces such as Global System for Mobile communications (GSM), Enhanced Data rates for GSM Evolution (EDGE), General packet radio service (GPRS), and other two-way wireless networks, transmissions using one-way, forward-only terrestrial wireless networks including TV, radio, and other broadcast networks transmitting information to the consumers, and transmissions using one-way, return-only terrestrial wireless networks including asset tracking networks and other end-user input capture and tracking networks. The terminology “wide-area communications” may also include transmissions using satellite networks including two-way and push-to-talk voice-based mobile satellite networks, two-way and simplex data mobile satellite networks (inclusive of location-identification networks), mobile satellite radio and mobile satellite video networks, and two-way, broadcast, and simplex data fixed satellite networks. Short-range wireless communications include those based on Wi-Fi, Bluetooth, UWB, ZigBee, infrared, DSRC, and NFC and other short-range wireless air interfaces, while wired communications include those based on universal serial bus (USB), Ethernet, Cable, Fiber, digital subscriber line (DSL), and other wired communication mediums.

When referred to hereafter, the terminology “transaction” includes but is not limited to task execution, process execution, application event, or any other type of data exchange.

When referred to hereafter, the terminology “assignment schedule” includes but is not limited to routing information including addresses, timing, hops, procedures, or any other instructions on action that are intended to be followed by the links to execute a transaction.

When referred to hereafter, the terms Multipass and NearVerse may be used interchangeably.

When referred to hereafter, the terminology “association” includes but is not limited to a connection between a source and destination endpoint. It can have multiple streams and paths as part of it.

When referred to hereafter, the terminology “path” includes but is not limited to one possible end-to-end route (that consists of multiple links) through which an Association can send traffic between endpoints.

When referred to hereafter, the terminology “stream” includes but is not limited to “stream” of data being sent between source and destination within an association. Each stream is used by a service at the upper layer.

Methods are described herein that allow an end-user device (end-point device), or multiple such end-point devices, to access other personal, mobile and portable user devices and other communication devices, including mobile wireless devices and consumer electronics, personal or localized relay/network nodes, including Internet access points and femtocells, and other devices, which may include mobile, portable, and stationary devices (collectively as relay devices), to access and use a variety of wide-range connectivity (i.e. Third Generation (3G)/4G/wired Internet network, satellite radio, mobile video, etc.) and other functionalities (i.e. processing, memory, power, enhanced RF, global positioning satellite (GPS), other location-identification apparatus, accelerometer, environment indicators, short-range signals, etc.) which are embedded within such relay devices, or are produced or accessed by them, (collectively referred to as enabled capabilities), and to otherwise interface with such devices for some other purpose derived as a result of such interface. Such relay EDVs may act as gateways between the end-point devices and the relay devices' enabled capabilities, including as servers, proxy servers, routers, and as relays, for both carrying out select functions requested of them by such end-point devices and also for transferring data back-and-forth as inputs, outputs, controls and synchronization, and content, by connecting to such devices using short-range communication, or any other form of communication that may establish direct, peer-to-peer links between relay and end-point devices.

As an example, a device may be equipped with only short-range wireless capability using one, or several, neighboring devices equipped with wide-area wireless capability to connect to the Internet. Another example is a device that's low on battery using a neighboring device that's high on battery to perform a specific computation in an instance, and then reciprocating such benefit when better charged to another device that's in turn low on battery.

The interfaces used may be serial, parallel, and hybrid interfaces between multiple enabled devices (EDVs), including multiple devices' interchanges collecting in a queue and serially interfacing to an EDV and multiple devices interfacing an EDV simultaneously in parallel. EDVs may have direct access via peer-to-peer interfaces. Additionally, access may be granted through a subset of the virtual network of EDVs, with devices performing one or multiple path hops through intermediate, relay EDVs, to access the enabled capabilities within a target relay EDV. Such access may be established automatically in advance of a specific access interaction on a persistent basis, or established according to an on-demand basis.

EDVs may select preferred paths or the path may be signaled to the EDV. As an example, a path for a data transmission from an EDV may be a series of one-hops to a series of proximate, relay EDVs. Because each of their accesses, and the device's embedded access, to the wide-area network, and the short-range access from all such relay EDVs to such device, are superior to such device's embedded wide-area access, on its own, and access to such relay EDVs via a series of one-hops to handle a portion of the overall data transmission yields the best connectivity performance. As another example, a multi-hop path through an relay EDV three hops away (a meshed path), such path dependent on each of the hops continuing to be in place for the duration of the interchange, may be calculated to be the best path for an alternative data transmission interchange even in light of circumstances, because it allows access through a Wi-Fi point, with a wired broadband connection, which happens to be substantially superior to all of the other alternatives one-hop away.

The cloud and its components, may be accessed any EDV that has been granted a proper authorization. For example, a party managing the enabled platform as its service provider may remotely control and configure when certain devices are disabled from access due to improper use. A vertical service may be offered, centrally augmenting some of the calculations undertaken at the individually EDVs, by processing tasks at distributed network points or centralized servers, or with a process or system that uses the combinatorial capabilities of the enabled platform, according to a set of conditions for such augmentation; an example of such vertical service is an enhanced location identification vertical service, revising the GPS-derived location identity of an EDV, with such device's relative position to other EDVs, and carrying out a large portion of the required calculations centrally, or via the remainder of the enabled platform, and then serving back the results of such calculations to such device.

EDV's may function as both, end-point devices and relay devices, executing the roles of each in accordance to demand and pre-conditions, with such functions being able to run in sequence to each other, or in parallel, on the same EDV.

An EDV's resources may be used by other EDVs for portions of desired functions, whether communication, co-processing, temporary remote storage, combinatorial functions, or otherwise, but then also permits potential acquisition of such resources given select circumstances. In the case of user applications, an EDV with a user application may be accessed by another EDV to use such user application, to try such application on a limited basis, or to temporarily access such application. At the same time, such user application may be downloaded by a second EDV from the EDV with such application, and installed on the second EDV. An EDV may be a relay and server of a resource's capabilities, and also a relay for, or a server of, the resource itself, and may serve such resource in response to another EDV's request, or alternatively act as a distribution conduit of a resource, such as a user application, prompting other EDVs to receive such resource and/or distributing such resource to other EDVs.

### Pre-Conditions

An EDV may be configured to identify the conditions for access to, and use of, its resources by other EDVs, including the availability of all or a subset of its resources, the time frame when such resources are available, additional conditions or situations when access/use to such resources is permitted, and even the subset of the other EDVs, or their user applications, that are allowed to access and use such EDV. Configuration of other conditions that control the access to, and use of, such EDV may also be implemented. Activation and termination of, and the conditions around, the use of EDVs are collectively classified as pre-conditions. The configuration of the pre-conditions may be pre-set and pre-loaded, or dynamically adjusted by the user or an administrator of such device, or by a third party.

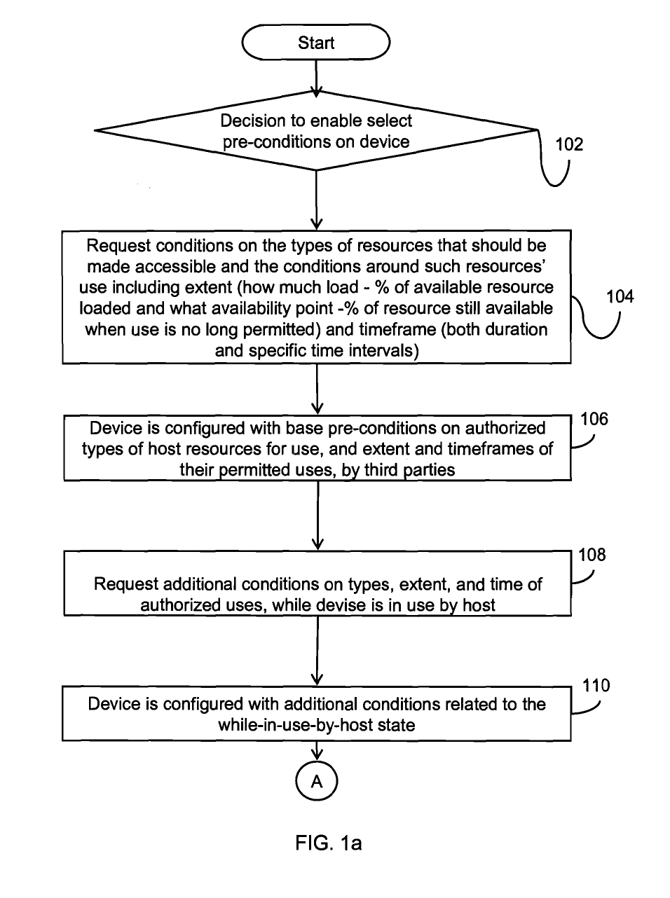

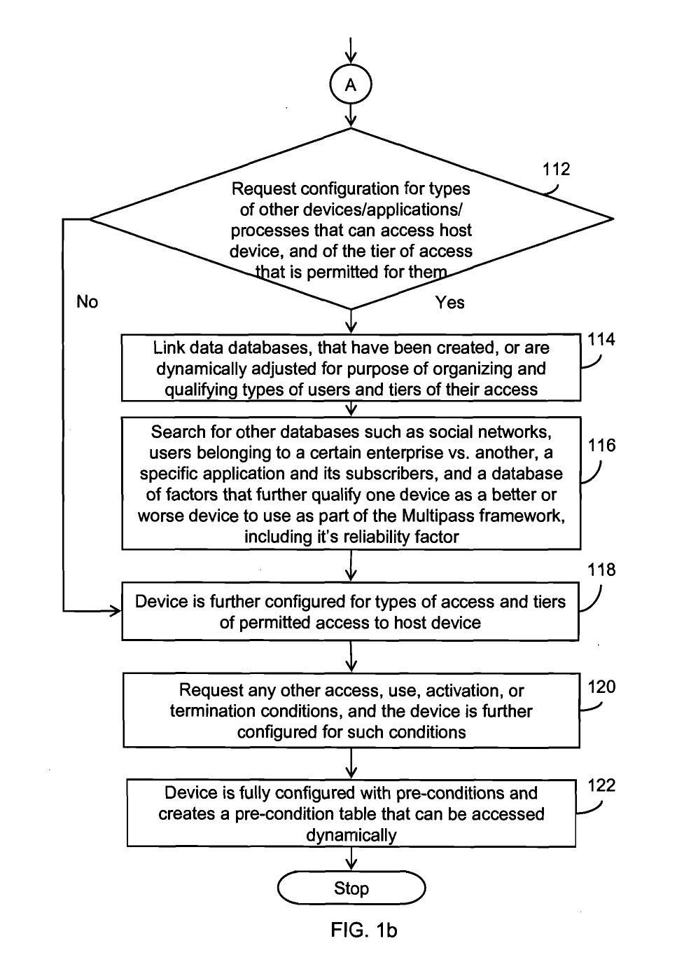

FIGS. 1a and 1b are a flow diagram for a method implementing preconditions. A pre-condition selection function is enabled (102). The EDV requests input regarding the types of resources that may be made accessible and the conditions around such resources (e.g. loading, percentage of available resource loaded etc.,), and the time frame (104). The EDV may be configured with base pre-conditions on the types of host resources that are authorized for use, and the extent and timeframes of their permitted uses by third parties (106). The device may request additional conditions on types, extent and time of authorized uses, while device is in use by a host (108). The device may further be configured with additional conditions related to the while-in-use-by-host state (110). The device may then request configuration types for other devices that may access the host device and of the tier of access that is permitted for them (112). The device may also link databases that have been created and are static or are dynamically adjusted, that organize and/or qualify the types of users and their access permissions between each other (114). EDVs are further categorized and ranked based on their relative standing, reliability factors, and other factors within groups such as social networks, users belonging to a certain enterprise, specific applications, etc (116). The device is then further configured for the types of EDVs that are authorized to access it, and the tier of access for which they are authorized (118). Any other access, use, activation, or termination conditions are requested (120). The device is then further configured for the desired pre-conditions for access to its resources and may then create a pre-condition table that may be accessed dynamically (122). In another embodiment, the pre-conditions to such sharing are fixed. In yet another embodiment, the pre-conditions are dynamic and change according to some further criterion or conditions.

EDVs may also be configured to operate in conjunction with social technology networking, where a set of pre-conditions may be related to the type of a relationship that an EDV has with another EDV. In such case, an owner of an relay EDV, or a user application on an relay EDV may pre-condition access to their EDV differently for the group of EDVs which are part of a common group or other social network, or that have higher priority, or that have higher reliability than other EDVs, or based on some other qualification, all such factors determined either by such owner or user application, based on their direct settings, or are configured based on the criteria provided by a third-party application or process, such criteria either accessible by, or linked to such relay EDV, for verification. Further, such selective pre-conditioning may apply to other EDVs, select applications on such EDVs or that such EDVs may access, or select resources available to such devices, or to any other circumstances or conditions, that may be deemed as advantageous to use for establishing pre-conditions to access a device, by such device's owner, user, administrator, user application, or a third-party application, person, system, or device that is accessing such EDV. For example, there may be a pre-condition allowing complete access and use of all resources of an enabled device, that belongs to an employee of Company XYZ, by all other enabled devices that belong to employees of Company XYZ, as long as the device's battery is 50% full, while restricting access to, and use of, only the communication capability of such device, and to no other resources, by all EDVs that do not belong to employees of Company XYZ. As another example, such pre-conditions may be based on a device owner's social network (i.e. Facebook), with different pre-condition sets matched to the different socially networked groups identified by the owner within such social network. As another example, such pre-conditions may be based on the type of a third-party application using the enabled platform, with access to resources of EDVs granted only to those other EDVs, which have the same type of an application on their EDVs and only for the purposes of access by such application; an example of such an application may be a VoIP client such as Skype. The pre-conditions may also be set based on the types of capabilities that a user application on an EDV may access. This may be set to identify the types of enabled capabilities that are permitted to be accessed, and prevent the types of capabilities that are not authorized to be accessed, by user applications, with different sets of pre-conditions used for different applications, whether for additional security purposes or to optimize performance in a unique way for such user application and EDV.

End-point devices and relay devices may be enabled to interface with each other dynamically, to collaborate with each other for access to and use of resources embedded within each other's devices. In summary, the term of art that is used to describe this revelation is NearClouds, where devices may be configured into independent mini-networks with other nearby devices, linked through direct device-to-device interfaces, may perform connectivity and functionality, using the capabilities of such mini-groups, and perform functions as collaborative mini-groups, in a way that's superior to their capabilities as independent devices.

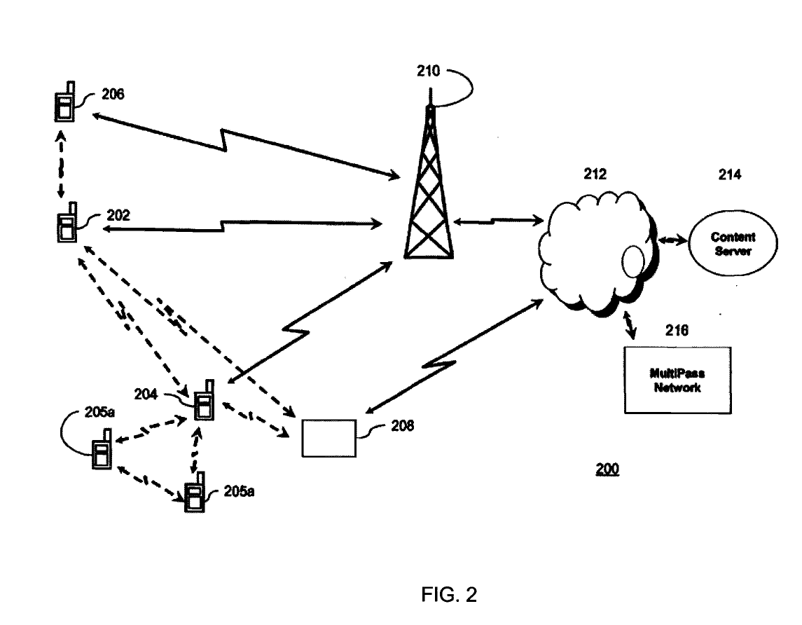

FIG. 2 shows a functional block diagram of a wireless communication environment 200. The communication environment 200 includes a mobile phone 202, a mobile phone 204, a mobile phone 206, and a Wireless Access Point (WAP) 208. The communication environment 200 further includes a Base Transceiver Station (BTS) 210 and the Internet 212, which represents the combination of networks that carry communication traffic. The mobile phones 202-206 connect to the BTS 210 through a wide-area Radio Frequency (RF) interface (i.e. code division multiple access (CDMA) evolution data optimized (EVDO) revision A), while the WAP 208 is connected to the Internet 212 directly through a fiber-optic cable. Further mobile phones 202 through 206 and WAP 208 are sufficiently proximate to each other to also perform communications links with each other directly.

Referring to FIG. 2, it is assumed that the mobile phone 202, the mobile phone 204, the mobile phone 206, and the WAP 208 are EDVs. In this example, the mobile phone 202 wants to upload a large data transmission stream to the Internet 212. The mobile phone 202 uses its proximate EDVs, mobile phone 204, mobile phone 206 and WAP 208, to augment the conventional solution above to upload the data.

In one embodiment, the mobile phone 202 periodically scans for proximate, EDVs and maintains a list of such devices in its vicinity, to facilitate expedient on-demand registration with such devices upon a transaction request, and it may register to the devices in advance of any such request.

In another embodiment, a central server maintains such records of devices and determines which ones are nearby by correlating their location coordinates, and then relays them to mobile phone 202 on request.

Upon identifying the set of proximate, EDVs with which to interface, the mobile phone 202 establishes a communication link with each of them. For example the mobile phone 202 may establish a link to peer devices using the Bluetooth interface and at the same time establish a link to peer devices using a cellular interface. The mobile phone 204, mobile phone 206 and WAP 208 also have connections with the Internet 212. In addition, the EDV may create a broken or indirect connection with a device using another device as an intermediate node. This devices act as routers and servers (for processing, computing, etc.) for other devices nearby. Using this configuration, routing and resource access may now occur from such mobile phone 202, using its embedded resources and its conventional link and/or using the 3 virtual connections through mobile phone 204 and 206, and WAP 208, to Internet 212 and vice versa. After mapping out the resources, the transmitting EDV contacts the destination node and request help from the intermediate nodes. Data packets to be transmitted are segmented and transmitted over the paths to the destination node. The destination node receives parallel transmissions over the communication from the multiple sources including direct nodes, intermediate nodes and the network and reassembles the information to generate the full message. By leveraging multiple communication mediums, the device receives the complete data transmission with improved throughput. The intermediate nodes may further be configured to cache the received data portion to be used in accordance with an intelligent cache method. Each node can act as a master or a slave in this environment and can simultaneously act as a master for one transmission while serving as a slave for another transmission. The scheduling assignment for transmission is determined according by the optimization engine.

In another embodiment, the data transmissions may be segmented by an EDV, so that the resulting data segments may be transmitted with greater granularity. Once segmented, in one embodiment, the mobile phone 202 transfers each data segment to mobile phone 204 through 206 and WAP 208 simultaneously, each such segment being transmitted in parallel. In another embodiment, the mobile phone 202 transfers the data segments in a sequential order, awaiting for the receipt of the data segment by one of the devices, before transmitting the next data segment to another device.

This embodiment may provide for multi-hop device-to-device communication. For example, the mobile phone 202 may have registered to interface only with mobile phone 204, but had the intelligence that WAP 208 was the best device to deliver a data transmission to Internet 212. In such case, after transmitting the data transmission to mobile phone 204, and assuming that mobile phone 204 was interfaced with WAP 208, the mobile phone 204 may then re-transmit the data transmission to WAP 208, which may deliver it to Internet 212. This may be useful when the transmission path to Internet 212 is calculated to be faster via one device versus the others, due to the robustness of the complete link from such device to the Internet 212. Thus, the WAP 208 may have a more robust link to the Internet 212 then either mobile phone 204 and mobile phone 206, while the short-range interface between mobile phone 202, 204, and WAP 208 is still robust, in which case it may be more efficient to communicate the data transmission using mobile phone 204 and as a relay to WAP 208 from mobile phone 202, and have WAP 208 carry the data transmission to the Internet 212—thus the multi-hop device-to-device relay.

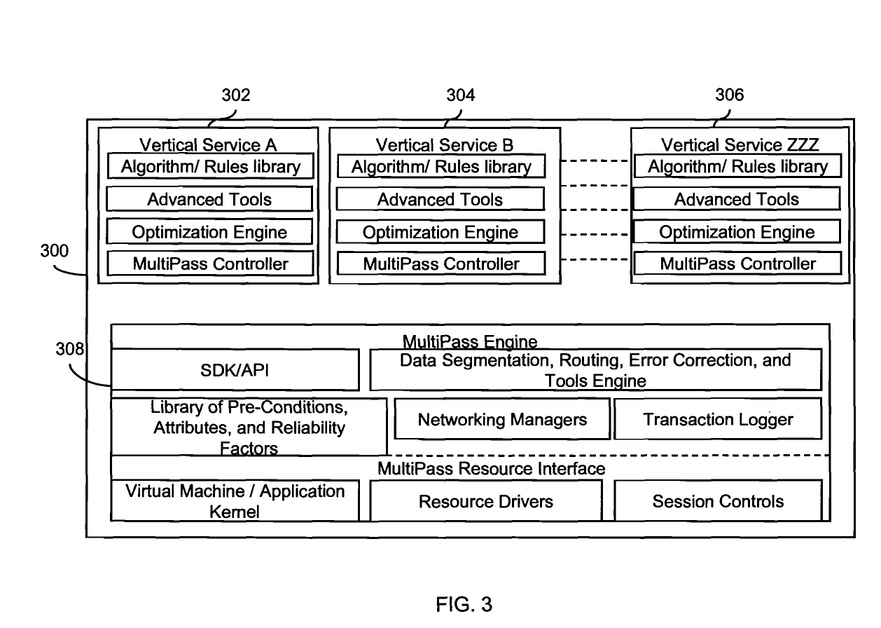

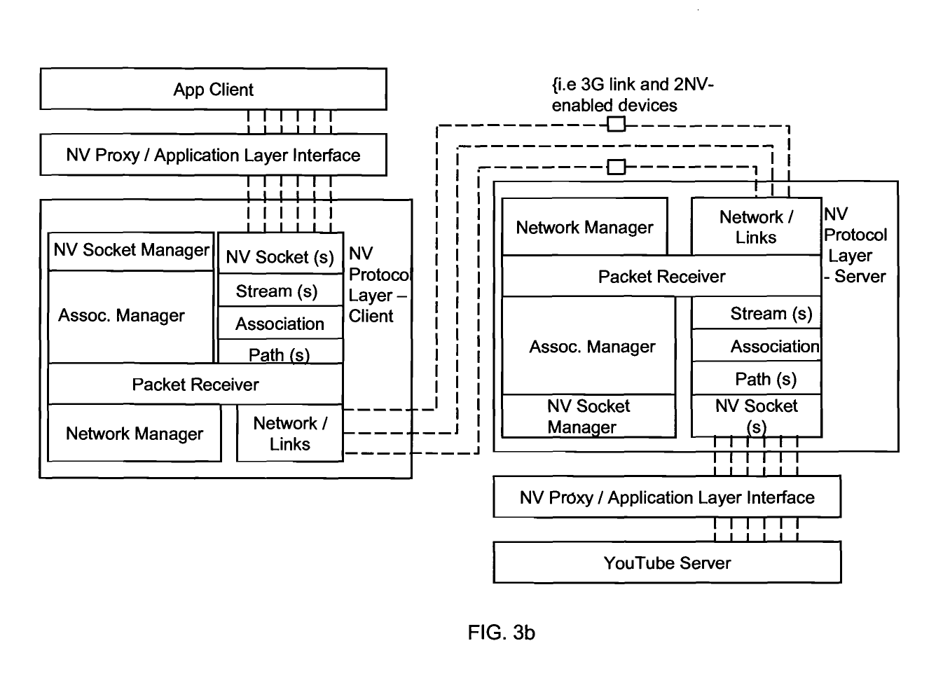

FIG. 3 is a block diagram of an EDV 300. The EDV may comprise vertical service modules (302, 304, and 306), a Multipass Engine and a Multipass Resource Interface (308). Each vertical service module may comprise an algorithm/rules library, advanced tools, an optimization engine, and a Multipass controller. The Multipass Engine may comprise a software development kit (SDK)/Application Program Interface (API) module, data segmentation, routing, error correction, and tools engine, a library of pre-conditions, attributes, and reliability factors, networking managers, and a transaction logger. The Multipass Resource Interface may comprise a virtual machine/application kernel, resource drivers, and session controls.

NearVerse System Architecture

NearVerse's core technology platform uses NearClouds to communicate in networking and computing environments.

Nearverse uses of “intermediate” or “indirect” NearVerse (NV) nodes as agents to execute functions in parallel to the traditionally direct processes. Through Nearverse scheduling, any node in a path may be converted into an intermediate node, including the cellular network itself. For sake of nomenclature, “NV Orig” refers to originating NV node, “NV Dest” refers to the destination NV node, and “NV Inter” refers to the “intermediate” NV node.

First, NearVerse uses a multitude of direct and indirect RF paths for each of its communications. Each device in the NearVerse system communicates with another NearVerse end-point directly, using 3G, Wi-Fi, Bluetooth or any other wireless RF interface. At the same time, each device also recruits the help of as many other devices, both wireless devices and Internet servers, NV Inters, as is possible, to improve the execution of such transaction. In these cases, the NV Inters are connected to the NV Orig, signaled to set up connections, either directly with the NV Dest or with other NV Inters that ultimately connect to the NV Dest in a sequence, to form a complete, end-to-end path for traffic flow from NV Orig to NV Dest through the NV Inter. The transaction then is executed using direct NV Orig to NV Dest link, in parallel with using one or multiple indirect RF paths, connecting NV Orig to some N number of NV Inters along the path to NV Dest for each one unique indirect end-to-end NV path. So the direct and indirect end-to-end paths may be bonded, for a NearCloud networking execution. Thus if a NV device A wants to connect to NV server A, it may have a direct 3G/Internet link to NV server A, but also recruit multiple NV Inters, devices B through N, and connect to devices using short-range wireless links like Bluetooth or Wi-Fi, have the NV Inters connect to the NV server A using their own direct 3G/Internet links, and use end-to-end paths through the NV Inters as respective additional, indirect end-to-end paths.

Second, NearCloud networking uses multiple RF resource to connect together devices within a predetermined range. In these cases, NV Inters also supplements the single direct links between two nearby devices, which are established using Bluetooth/Wi-Fi, with multiple indirect end-to-end paths through NV Inters as per above, in which case the NV Inters can be other nearby devices (connected to by NV Orig using Bluetooth/Wi-Fi and which in turn connect using Bluetooth/Wi-Fi to NV Dest, or other NV Inters as subsequent intermediaries before ultimately reaching NV Dest) or NearVerse servers (connected to by NV Orig using 3G/Internet and server connected to NV Dest using 3G/Internet in turn). The direct and indirect end-to-end paths are similarly bonded, for a NearCloud networking execution.

Third, NV nodes, including NV Inters may be “intermediaries”, serving not only as routers but as “intelligent routers”. They route packet flow along the indirect paths, cache packet flow, multicast packet flow to multiple devices, seed the system of other “intermediaries” with packet flow for their further function as “intermediaries”, creating a directory of packet flow available at the intermediaries, and performing other additional functions on the packet flow to improve the system.

NearVerse may use these features for computing, processing, use of power, and otherwise, where “intermediary” devices, including other mobile devices and servers, are accessed using short-range and 3G RF links to be used in a complete NearCloud of nearby devices to execute other processes, to supplement the main NV executor of processes.

NearVerse Network Architecture

NearVerse network architecture uses a combination of unique major elements to carry out its operations. Systems, application protocols and services, transport protocol, network abstraction, and device abstraction. Systems level comprises a sub-systems that facilitating and secure operation. These include provisioning, termination, and accounting, security, clearinghouse, network management and load balancing, etc. Application level protocol facilitates effective discovery, directory, session control, and traffic delivery. Application services include services like location ID technology. Transport protocols include NVTP and other transport/packet layer protocol implementations. Network abstraction includes the network interface to all of the networking links that NearVerse uses for its protocols, and the provisioning/tear-down of those links. Device abstraction includes the OS interface and virtualization or secures environment partitions that NearVerse executes, to run NearVerse software.

NearVerse Protocol Layer—Architecture

FIG. 3b is a block diagram showing Nearverse Protocol Layer Architecture. NearVerse Protocol Layer has three key components—External interface layer (external traffic route interfaces/APIs), NearVerse protocol engine (traffic processing), and NearVerse interface layer (internal NV traffic route interfaces).

In the NearVerse External interface layer, applications and upper layers of NearVerse stack interface the NearVerse Protocol Layer through NV Sockets. The NV Socket Manager then assures that a given NV Socket is authorized and presents the rules by which it is authorized to the protocol layer. NV Socket then defines the source, destination, and rules/service type (TCP vs. UDP, unicast vs. multicast, etc) for the ordered transport protocol service desired by the upper layers for this traffic stream.

NearVerse traffic processing is performed by the NearVerse protocol engine. First, the NV Socket Manager sends a request to the Association Manager to create an individual stream on a one-to-one basis for each NV Socket. The Association Manager creates a stream for each NV Socket and uses that stream to define the intended traffic flow on an end-to-end basis from the source to the destination, the service that the transport layer will provide, and the buffer/windowing components of the protocol at the Stream level. Second, the NearVerse Association Manager creates an Association and matches each unique Stream to one unique Association within the NearVerse system—the association represents a unique set of NearVerse end-points that are the preferred set of NV nodes (NV ingress/egress for intermediate, or NV end-points) that traffic should flow-through, to reach source or destination. A NearVerse DNS system that determines the set of NV end-points that a stream traverses, and reports that information to the Association Manager to create the appropriate association. Once the association is created to support a given stream, the Association Manager tracks the streams and matching associations through a token system. The Association Manager then creates and maintains a directory of live associations mapped to live streams.

Third, the Association Manager queries the Network Manager to identify and present to the Association Manager the available links to use for transport. Once the Network Manager returns the available links to the Association Manager, the Association Manager provides the knowledge of that link to each relevant association, and each association establishes a unique path for each link. The path represents the end-to-end, intra-association route from the NV source association node to the NV destination association node. The Association Manager inventories the utilized streams, associations, and paths, and relays the info to/from the external and NV interface layers to assure availability of matching NV Sockets/Links and to terminate them as appropriate.

Fourth, the protocol engine has a reciprocal interface, the NV Packet Receiver, that serves to intake traffic coming from the NearVerse interface layer and route it accordingly to the associations.

This NearVerse interface layer manages the network interfaces, and incorporates the Network abstraction layer. The NearVerse interface layer performs a) network discovery, b) network activation/de-activation, and c) NVTP links activation/de-activation.

There are three network discovery states on, off, and hybrid. In the on state, the device can see other devices on the network and the device is visible to other devices. In the off state, the device cannot see other devices and cannot be seen on the network. In the hybrid state the device may be visible but cannot see other devices or vice versa.

Networks interfacing with the interface layer include neighboring NV-enabled devices/networks across each of the available network interfaces including 2G/3G/4G, Wi-Fi Infrastructure to the Internet, Wi-Fi Infrastructure to other devices, Ad-Hoc Wi-Fi, Bluetooth, and any future interfaces including Wi-Fi Direct, NFC, and emerging 802.x family of interfaces. NVTP links include UDP/TCP links over available interfaces. NearVerse interface layer executes discovery per instructions and identifies all of the available networks, sets-up networks and NVTP links, accommodates traffic flow from the associations through the NVTP links and to the associations from the NVTP links through the NV Packet Receivers, and terminates the NVTP links when they are no longer required. Discovery and network set-up uses different protocols depending on the network interface type, with some interfaces assumed to have already provided available network links (i.e. 3G is activated external to the NearVerse interface layer today in iPhone for instance), while some interfaces require lower layer discovery and network set-up (i.e. ad-hoc Wi-Fi can only be set up by activating ad-hoc Wi-Fi mode and then establishing hotspots).

NearVerse interface layer sets-up direct links that comprise a direct path, as well as multiple indirect links that make up an indirect path, that connect a source NV node (i.e. an NV device) to another NV node (i.e. another NV device), that in turn acts as an intermediary routing point, to yet another NV node (i.e. the NV server). NearCloud networking is not limited to the intermediate/routing NV node to being one NV device, but instead can be an NV server especially for device-to-device Associations (and thus an indirect Path could be an NV device to NV server to NV device), and can also be a multi-hop Path (and thus an indirect Path could be an NV device to NV server to NV device to NV device). In sum, a direct path is one that connects an NV node to another NV node through no other NV intermediaries, and an indirect Path, is one that connects an NV node to another NV node through a series of NV intermediaries, which can be NV server(s) and/or other NV device(s).

NearVerse flows include flows between a) an NV device and a given Internet-connected point, b) an NV device/NV server and another NV device, and c) a multitude of NV devices/NV server to a given NV device. In each case, while a direct Path between two point, that's a normally preferred path is expected to be initiated first and used as the dominant Path initially (i.e. 3G for NV device and given Internet-connected points transactions, ad-hoc Wi-Fi for NV device to another NV device), other Paths, including indirect paths through intermediate NV nodes, including other NV devices, provide parallel traffic routes, all of which are utilized per their advertised “windows” and corresponding ability to support a given volume of throughput to carry an intended Association's traffic and process flows.

NearVerse Protocol Layer (External Interface Layer)—Protocol

Each NV Socket is used to match traffic flow requirements outside of the NearVerse system. On the client, it's the interface with the applications/application layer. In most case, the interface to applications is handled through a Proxy/Application Protocol Layer, but applications can also interface the NearVerse Protocol Layer directly. On the server side, it's the interface with third-party servers/devices that are the ultimate end-points for traffic. Just as on the client, these interfaces are often handled through a Proxy/Application Protocol Layer.

NearVerse Protocol Layer (NearVerse Protocol Engine)—Protocol

Each association represents one discrete protocol engine function/end-to-end NearVerse executable process. The NearBoost patent alone is specified for multiple discreet protocols, including traffic performance, traffic pseudo-multicast, traffic location-based caching, and other possible algorithmic protocols.

Each stream is used to match external traffic flow requirements to the NearVerse system. A core function of each stream is to match up buffering on both ends of the NearVerse system for a given unique stream, to facilitate adequate buffer congestion control on an end-to-end basis. The stream structure holds a send and receive buffer that gets utilized by the association and the external application or service that is utilizing the stream. The stream also holds a receiver window (RWND) for the stream. The advertised window sent to the opposite NV node (NV destination) is equal to the amount of available space left in the stream's receiving buffer. Data can then be sent through a Stream as long as the amount of data in transit is less than the advertised receiver window of the opposite NV node stream. If at any time the amount of data in transit is more or equal to the opposite NV node stream's advertised window, then no more new data is sent on that. So the stream throttles how much traffic it's able to accept from each NV Socket, depending on the buffer congestion on the other end of the system.

Each Path is used to establish a “window” to estimate the rate of throughput and quality of routing through each individual network interface/link available to the device, on an end-to-end basis (so through the link, and any subsequent links if an indirect Path). These “windows” are established through a combination of proactive algorithms (driven by known information at the device) and reactive information (received ACK-SACK information from the other NV nodes). Using ACK-SACK information, RTTs are identified for the packets, and a time-out counter is established for the “window” on each Path, which expands and contracts and provide the best estimation of the rate of throughput and quality of routing that can be expected through each Path. Paths are also always initiated using the Path initiation process, and initiation includes any intermediate NV nodes that are linked together, between the NV nodes that are sources and destinations for a given transaction, to act as pass-through of traffic or routers for the NearVerse Transport Protocol.

The protocol utilized across each Path is a modified TCP-like protocol. Initial congestion window is set using a modified, TCP-like, slow-start-like algorithm and then increased/decreased according to slow-start-like algorithm per its congestion interpretation rules (exponential increases), or until the slow-start-threshold is attained, at which time a modified, TCP-like congestion-avoidance-like algorithm is used instead. The congestion-avoidance-link algorithm is then used per its own respective congestion interpretation rules (linear increases/decreases). If this algorithm detects excessive losses, then it may revert back to the slow-start-like algorithm again depending on when the occurrence happened.

Each association is used for end-to-end execution. An association takes packet flow off of each stream and matches it to the paths that are available based on the “windows” of each path, in a continuous fashion. The association also then tracks ACK-SACK information to calculate when packets need to be re-transmitted, which is at least in part derived from the same RTTs and time-out counter that's established for the “window” of each path, and re-transmits any “deemed lost” packets across available paths.

Pass-through Associations are special associations that are used to intermediate traffic through a given NV device when an NV device is used as a router in the system, between a source and destination NV node. Thus, pass-through Associations are routing Associations. Unlike normal Associations, which are unique for each source-destination set, there is only one pass-through Association per device which handles the routing of all intermediate traffic from other NV streams and other NV servers.

All streams, associations, and paths of a source NV node are initiated, used, and closed on a symmetric basis at the destination NV node.

Networking Layer

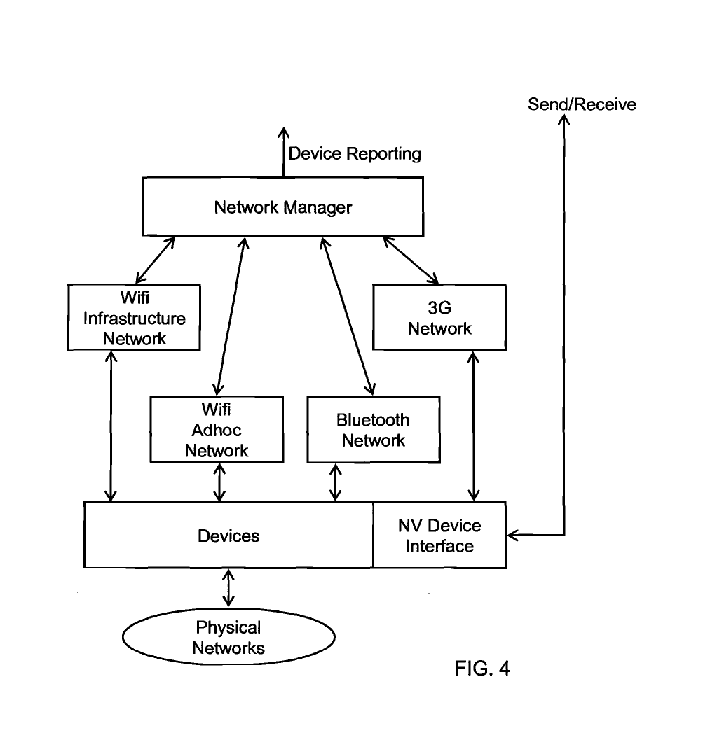

FIG. 4 is a diagram of a Networking Layer. The Networking Layer establishes physical links over the available transports. It comprises a Network Manager, a group of physical networks, and a group of available devices on each of those networks.

Network abstraction includes the network interface to the networking links that NearVerse uses for its protocols, and the provisioning/tear-down of those links.

Network abstraction includes the network interface to the networking links that NearVerse uses for its protocols, and the provisioning/tear-down of those links. NearVerse interface layer serves to set-up direct links that make up a direct path, as well as multiple indirect links that make up an indirect path, that connect a source NV node (i.e. an NV device) to another NV node (i.e. another NV device), that in turn acts as an intermediary routing point, to yet another NV node (i.e. the NV server). NearCloud networking can be an NV server especially for device-to-device associations (and thus an indirect path could be an NV device to NV server to NV device), and can also be a multi-hop path (and thus an indirect Path could be an NV device to NV server to NV device to NV device). In sum, a direct path is one that connects an NV node to another NV node through no other NV intermediaries, and an indirect Path, is one that connects an NV node to another NV node through a series of NV intermediaries, which can be NV server(s) and/or other NV device(s).

NVNetworkManager

The NVNetworkManager monitors and manipulates the networks on the system. It spawns new thread for each network that should be running and provides information from all networks up to the classes that need them. When a network device becomes available, the network manager will be notified by the network and will pass that information along to the higher classes. When a higher-level class makes changes to the way networks should be handled or used, the Network Manager enacts those changes in a timely manner.

As security is important, client-side authentication, with centrally administered encryption keys, where device interactions are permitted only following acquisition of secure keys from a central server, which are time and privilege gated and renewed according to intervals of change in time or privilege, may be performed. Alternatively, the encryption keys may be accessed at proximate devices, which are previously enabled and authenticated, to minimize use of wide-area access and capitalize on robust, short-range availability. The level of authentication may be dynamically adjusted to be tied to a device's secure key database or key generating algorithm or to be managed through the virtual network and network management system, to balance the amount of time and resource consumed for process with the required level of security. Authentication may also be linked to pre-conditions, including to sub-groups of EDVs, capabilities, user applications, or otherwise, where one set of security techniques are used for one sub-group, and another, more lax or more stringent, set being used for another.

As another function, once installed onto, or activated at, an end-point or relay device, a query is made to the device to identify a comprehensive set of resources available to a device. An interface is then established to a subset of resources, and then is mapped to an application interface platform, to enable access to and use of resources according to a set of pre-conditions, for the purpose of executing the functions of an enabled end-point or relay EDV as appropriate, and allow additional vertical services to access and use resources for further benefits. The embedded set of user applications on the device then identify and interface, or are identified and interfaced by, the Multipass platform. The Multipass platform also establishes an interface for future user applications on the device to be identified and interfaced by the platform and vice versa as above, to enable user applications to access and use the enabled capabilities via the platform.

This Multipass platform further provides an interface to control tasks and to adjust the pre-conditions on a user device. The interface (e.g. GUI) may be resident on the EDV, or via web or remote application. In yet another embodiment, the user and administrator interface that is resident on the EDV, is augmented in functionality by a web or remote version of the interface, allowing the resident version to perform a subset of the potential functions of the interface, the web or remote version to perform the same or different subset of the potential functions, and for the two versions to synchronize or jointly perform the same or yet a different subset of the potential functions of the interface.

EDVs may register and communicate with other EDVs on a secure basis independent of the other EDV's operator. Communication may include session commands and control, routing, access to, and use of, EDVs' enabled capabilities. Some EDVs may have access to administrative privileges for other EDV's depending on the pre-conditions/granted permissions.

### Interconnecting and Virtual Network

Relay and end-point EDV's may form interfaces with each other to establish direct connectivity with EDVs, or with a virtual network of EDVs. The devices may be configured with network management and operating controls, including engineering and commercial methods, to manage interactions.

Device interfaces may be registered, at the time that an application event requests access to the enabled platform for the benefit of an EDV. Alternatively devices are pre-registered when devices are in proximity or in anticipation of a transaction. A virtual network of EDVs may be established when a relay EDV is interfaced to an end-point EDV. In another embodiment, a virtual network of devices is established and synchronized with centralized network management resources. Alternatively a management control plane is formed via a collection of EDVs that managing and control the virtual network.

EDVs may initiate automatic registration with other EDVs in a predetermined proximity range. The automatic registration may comprise all or a subpart of the registration process required to establish connectivity. In another embodiment, EDVs may negotiate registration with each other on an on-demand basis, once a transaction between EDVs is contemplated. Registration may be performed on a direct peer-to-peer basis or a central control center, which may provide registration information for all EDVs in the vicinity and manage their synchronization with each other centrally, by sending out registration acknowledgements. Registration may be updated for devices entering and leaving the same geographic proximity.

In multistage registration, EDVs are pre-registered to interact with each other automatically once in vicinity of each other and are aware of each other and each other's network identities. The complete registration is triggered only when a given EDV is notified that another EDV desires to perform, or is imminently performing, a data transaction. The EDV taps into the pre-registered interface, activates itself as part of the virtual network, and waits further instructions. Pre-registration confirms the devices' ability to interact and establishes the exact set of interfaces the devices may use. The devices do not establish active channels between each other, beyond the limited pre-registration interactions, until they are prompted to do so at the time of the intended transaction.

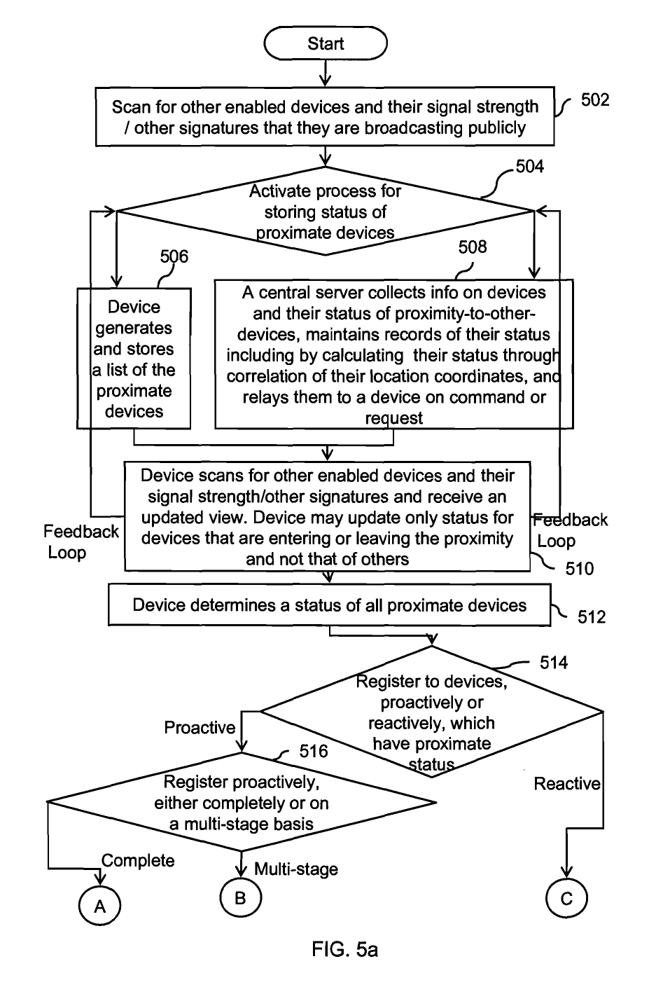

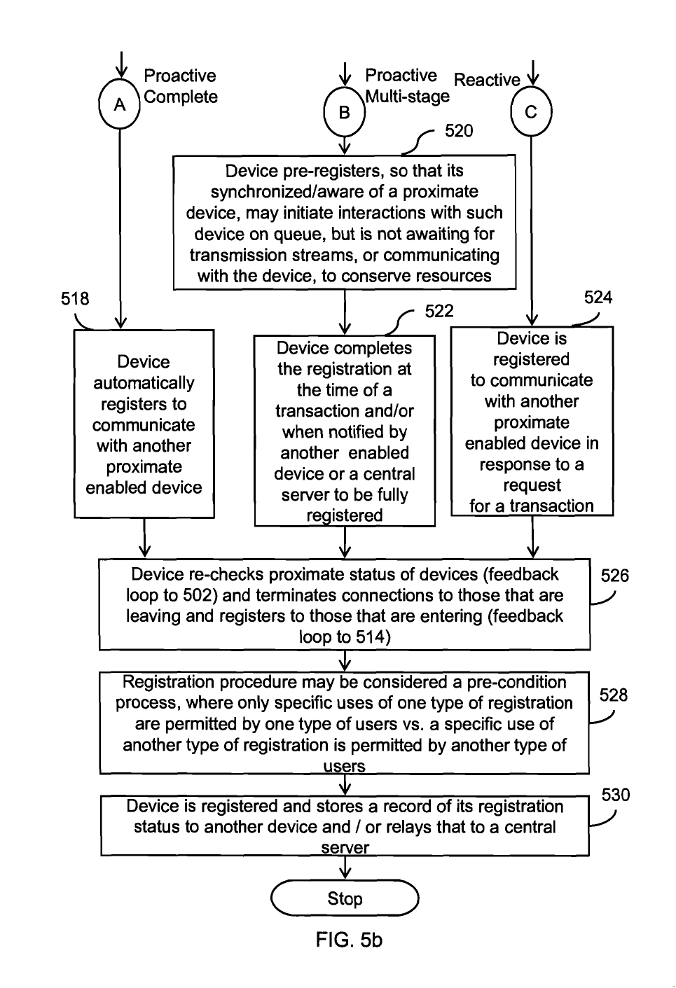

FIGS. 5a and 5b show a method of registration. An EDV may periodically scan for proximate EDVs along with the signal strength and other signatures of the proximate EDVs (502). A process is activated for storing the status of the proximate EDVs (504). The EDV may maintain a list of EDVs in its proximity through the use of short-range wireless signaling (506). This may facilitate on-demand registration with devices upon a transaction request. A central server may also maintain records of devices, including by having devices upload the results of their short-range wireless signatures or their location coordinates and subsequently correlating devices' information to identify their proximity to others, and then may relay coordinates to the EDVs on request (508). The scanning may continue from 504 to 508 updating the list of EDVs proximate to a given EDV, and may update status for only those devices entering or leaving the proximity of the device (510). The EDV may then register to the EDVs that have proximate status (514).

Depending on the settings, the EDV may perform a proactive registration or a reactive registration. In reactive registration, the EDV is registered to communicate with other proximate EDVs in response to a request for a transaction (524).

In proactive registration there may be two options, proactive complete registration and proactive multi-stage registration (516). If the device performs a proactive complete registration, the EDV automatically registers to communicate with the proximate EDVs, irrespective of the imminence of a transaction (518).

If the device performs proactive multi-stage registration, the EDV pre-registers so that it is aware of the proximate EDVs to initiate interactions with the device on cue (520).

The EDV then completes the registration at the time of an intended transaction or when notified by another EDV or a central server to be fully registered (522).

After registration, the EDV may re-check the status of proximate EDVs and terminate connections to those that are leaving the proximity and registers devices that are entering the proximity (526). Registration procedure may also be subject to a pre-condition process, where different registration procedures are used for different user or application groups (528). The EDV then stores its registration status and similarly updates the central server with its registration status information (530).

An end-point EDV requesting a transaction may be to be a hotspot or a master, and the other proximate EDVs may serve as slaves to the master, registering to the master to serve as relay EDV. In that case, the end-point device enabled as a hotspot or master acts as a multiple-access server for upload transactions, and a multiple-access client for download transaction, and reverses general data flow from it to the Internet, in the sense that it acts as a hotspot but is also a destination, instead of an intermediary to Internet access. Each relay EDV that is registered to the end-point EDV then in turn relays data, as it receives it from the end-point EDV to the Internet for upload transactions, and vice versa for download transactions.

EDVs may be woken up to perform as relay EDVs, registering to the end-point EDVs, and potentially to each other, and carrying-out the directed transactions for data flow with the end-point EDVs and with the Internet, and are directed to based on a set of scheduling instructions. Additionally, a master address table may be generated matching IP addresses for each EDV and in-network node. Each assignment schedule cross-references each link against the master table, as well as identifies the IP addresses of the source and destination, if either the source or destination is not an in-network node or EDV.

Once interfaced, the EDVs may use the resources of other EDVs nearby. The virtual network may be configured to route and compute by using multiple EDVs within the virtual network in some combination (network flow). Resources of multiple proximate EDVs may be selected based on its best fit for the requirements of a specific transaction. For example, a vertical service may use the virtual network to pre-configure the traffic flow within a virtual network, and dynamically re-balance it as the traffic flow progresses to facilitate that the best set of devices and paths are selected for the performance of a vertical service function. Furthermore, the virtual network supports multiple hops. The intrinsic capability of the virtual network is to select paths and number of hops based on a predictive view and reactive view on hop conditions, and to optimize for best paths. Vertical services may take into account the dynamically changing path conditions to structure the preferred form of network access, as well as assure path integrity in the case of terminated path-hops while in-session.

The network flow may be provisioned from an EDV to a central server, which may allow for controlled delivery of communication through the virtual network. For example, a video stream may be delivered from a network server to an EDV, on a controlled basis using the virtual network. Further, the virtual sub-networks of interconnected EDVs may be pooled into a broader enabled platform of sub-networks and their network flow may be managed synchronously. This allows offering the virtual networks to end-users as managed service platforms that may be synchronized and managed on a large scale basis. Lastly, this approach allows for specializations of EDVs, where some devices have access to different resources and may contribute to the virtual network in different ways. With knowledge of the pre-conditions and the available resources of the EDVs, an EDV may use the other devices of the virtual network, with a different device being selected for a different set of capabilities depending on the circumstances.

Overall, the virtual network configuration allows for transactions to be managed and monitored and creates an opportunity for transactions to be reconciled against transaction requirements or for remuneration purposes between the parties. The virtual network allows for vertical services to be developed to use the EDVs within the network on a true network basis, optimizing scheduling, synchronizing interactions into a planned process, and using enabled capabilities of a cloud, in parallel and passively to the devices' users.

### Virtual Resource Operating System

The Multipass platform, activated at any EDV, and the enabled platform as a virtual network function as a virtual resource operating system to enable the use of the content and applications and the network platform. This virtual resource operating system may be connectivity and computing platform for EDVs, and may be accessible in parallel to the resident connectivity and computing platform of an EDV. Alternatively, the virtual resource operating system incorporates the resident connectivity and computing platform to offer a unified resource operating system, and provides for access to both via one interface. The EDVs in the virtual network are accessible to end-point devices as an extension of their device. Further, vertical services may be developed that use the enabled platform and embedded capabilities on a uniform basis, to provide technology capability that is independent or combinatorial to a given user. Also, user applications may be linked at an end-point device, or otherwise, that use the enabled capabilities, and the enabled platform.

EDVs, functioning as a virtual resource operating system, may provide several key interfaces—to vertical services, to content and service providers, and to user applications. For vertical services, this includes interfaces necessary to create vertical services with additional capabilities, including developing software code and additional infrastructure, that use the enabled capabilities accessible through the enabled platform and the additional functionality already made available by the enabled platform, for a higher functionality enabling technology. Users may access vertical services through the enabled platform, using the interfaces provided by the enabled platform for access. For example, if the group computing vertical service and the previously described performance optimization vertical service are two vertical services, then a user application, on the one end, and content and service providers, on the other end, may access the enabled platform and its inherent capabilities, as well as tap into two vertical services as plug-ins to the enabled platform, to more effectively execute their intended functions.

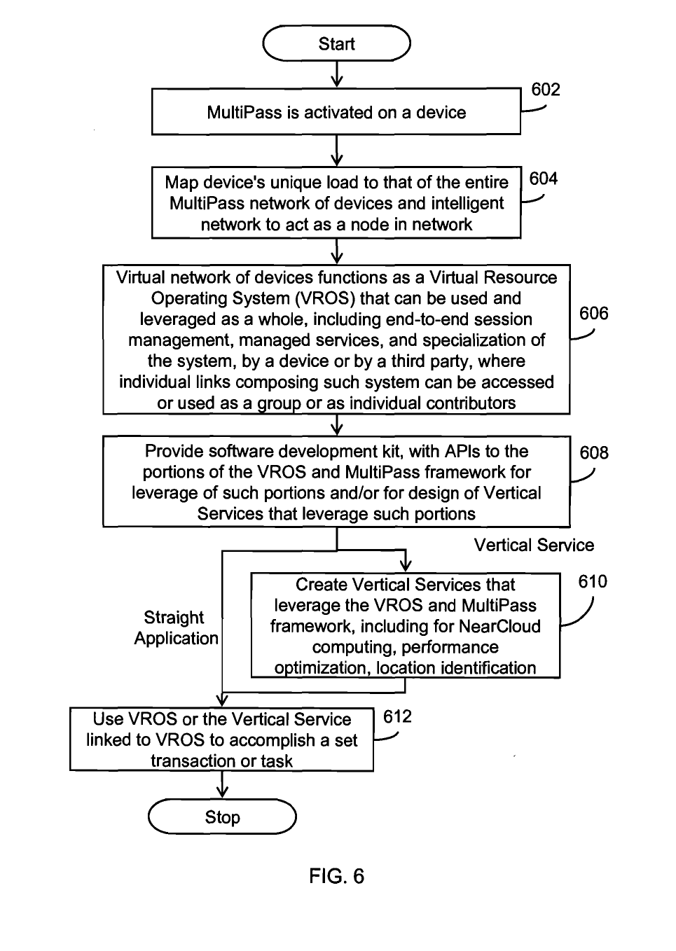

FIG. 6 is a flow diagram implementing a method for creating a virtual resource operating system. A device is enabled with the Multipass platform (602). The EDV's unique load is mapped to the entire virtual network of Multipass EDVs to act as a node in the network (604). The virtual network of devices may function as a Virtual Resource Operating System (VROS) that may be used as a whole, including end-to-end management, manages services, and specialization of the system, by a device or by a third party (606). An SDK is provided for the design of content and applications that use portions of the VROS as part of their connectivity to the user, or base functionality, and for the design of vertical services (608). Vertical services may be created that leverage the VROS and Multipass framework for performance optimization, location identification, and other independent or combinatorial functions (610). The EDV may then use the VROS to perform a task (612)

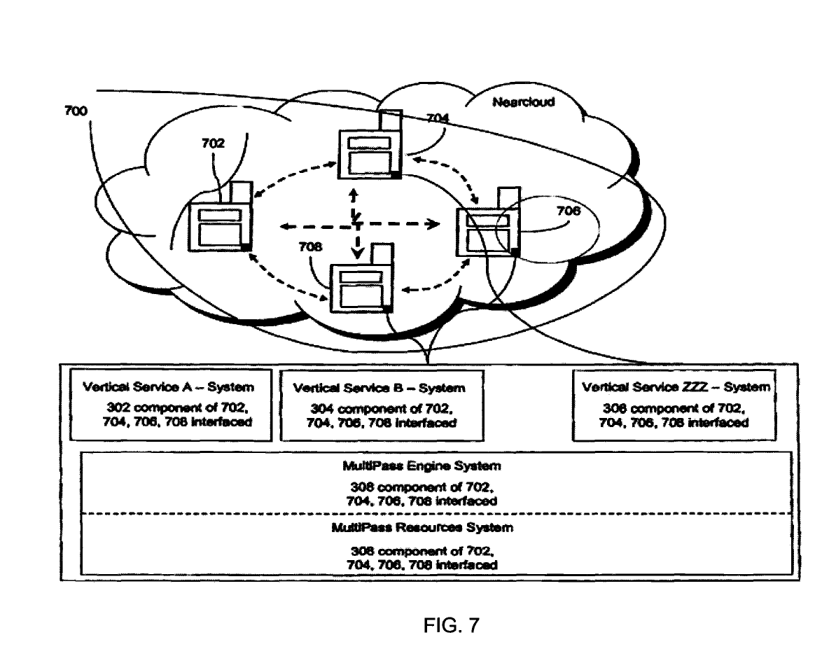

FIG. 7 is a block diagram of a VROS within a single NearCloud 700. The NearCloud contains devices 702, 704, 706, and 708, all interconnected as part of the virtual network. The, the Multipass Engine and the Multipass Resource Interface of each device, component 208, are virtually interconnected within the NearCloud 700. The vertical service modules of each device, components 302, 304, and 306, are also virtually interconnected within the NearCloud 700. Any given EDV 702, 704, 706, or 708, or a combination of the devices, or some other third-party application or service with access to the enabled platform, may then execute transactions or use vertical services to execute higher-order transactions using the NearCloud 700 as part of a VROS.

As vertical services are developed, they may also interact with, and be used by, other vertical services, or be used in combination with them, for some additional higher level value-added benefit, than each one of them separately. Vertical services may be added into the core fabric of the enabled platform over time, to form its baseline (see the WiMAX standard, Institute of Electrical and Electronics Engineers (IEEE) 802.16, and its evolution).

In summary, the collections of devices that may be enabled, as well as the interfaces embedded within each EDV, create a horizontal platform of EDVs that functions like an operating system, such as Google's Android OS.

### Network Management and Clearinghouse

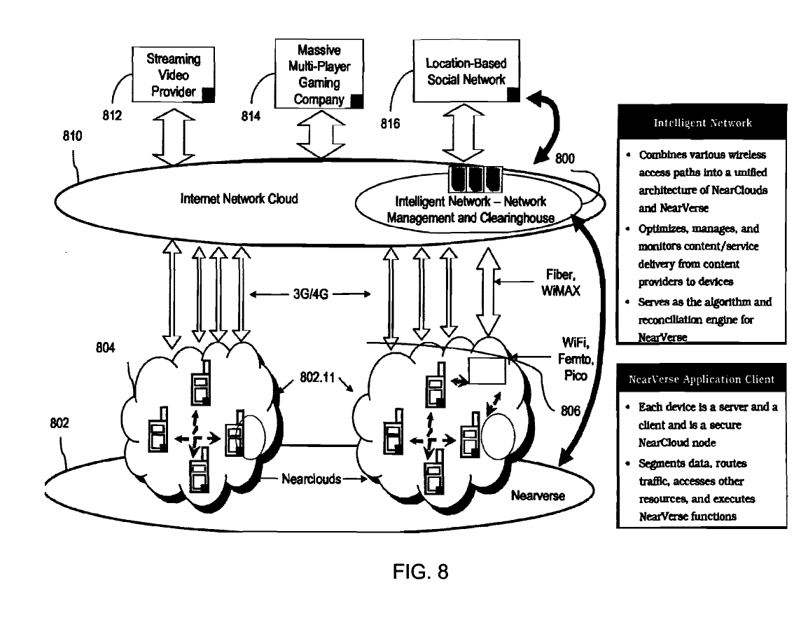

FIG. 8 shows an example system for network management and clearinghouse. The system may include a streaming video provider 812, a multiplayer gaming company 814, a location-based social network 816, an internet network cloud 810, an intelligent network, network management and clearinghouse block 800, Nearclouds 804 and 806, and the enabled platform 802. The EDVs and the intelligent network for the enabled platform may be configured to carry out network management and administration of the enabled platform, and to clear of connectivity, processing, storage, and all other interactions that occur over the entire enabled platform, in a uniform and consistent manner although fully customizable, with clearing inclusive of interaction processing, recording, commercial reconciliation, and other clearinghouse functions. Capabilities may be packaged as embedded vertical services of the enabled platform, and additional vertical services, designed to carry out managerial and clearing functions, may also be developed to either augment capabilities or to replace them, for use by specific applications or EDVs, or generally otherwise. The methods may be executed by the EDVs, independently performing the above functions related to the EDV, by a server or on a centralized basis, performing the above functions for the assortment of the EDVs without their involvement, or on a hybrid basis, with portions of the capability required to perform the above functions handled at EDVs and other portions handled centrally.

One vertical service is the network management system, which may allow for optimal network performance of the enabled platform, and performs authorizing, monitoring, and management of the interchanges in accord with end-user preferences and desired execution of interchanges. As an example, a network solutions suite, combining server/routing hardware and network management software, is established by a service provider of the enabled platform, and a network management client is embedded within the resident method and loaded onto an EDV, and the system is then used by the service provider to monitor and control the networking interchanges, including the uses of, and access to, enabled capabilities, between the EDVs. The administration and control of the interchanges may be performed by a central control center, where in one embodiment the networking interchanges flow through the control center, in another embodiment, via a remote monitoring function where EDVs and their activities are tracked through feedback to the service provider collected from the EDVs interchange logs, or otherwise via a distributed server architecture, where enabled software may be deployed at a variety of distribution points within a telecomm network, including at edge servers and routers, and the distributed enabled network points may interchange traffic between the enabled platform and other telecomm providers, as well as in turn be monitored and controlled by the service provider remotely. The network management system may further serve as a gateway to the enabled platform and to peering with third-parties. The system may manage the interactions, including employing a variety of other vertical services. The enabled platform may be packaged by a service provider, with the network management system, into a managed service offering, ensuring end-to-end performance and capabilities across the enabled platform. As an example, a managed service offering may resemble mobile virtual network operators (MVNOs) such as Virgin Mobile, offering virtual consumer services over top of someone else's infrastructure, or resemble content distribution networks such as Akamai, offering intelligent networking and content distribution by using edge servers.

Another vertical service is a clearing platform that manages the clearing of commercial relationships, which are associated with network interchanges that occur over this enabled platform. Just as the virtual network connects all of the EDVs into a uniform enabled platform, that may be managed and used as a platform for routing, service delivery, and combinatorial applications, the clearinghouse allows all of the transactions that occur on the enabled platform to be tracked and to be reconciled, for commercial costs and benefits, including for access to, and use of, the resources of EDVs, and for use of other third-party resources and other supply chain functions. Just as described for the network management system, the clearing may operate through a central point, through feedback from EDVs, or through remote management of distributed enabled network points. The reconciliation includes linking the interchanges to selected commercial plans, billing service subscribing entities according to the rates for interchanges, collecting the funds, and distributing funds to ecosystem suppliers of the enabled platform including network operators, equipment OEMs, end-users, distributors, and other parties in the ecosystem, working to both reimburse and to incentivize stakeholders in the value chain, treating each EDV as a network and business node. For example, the forms of re-imbursement may include on-demand transactions for, or sub-leasing of, EDVs' resources, ad-supported or fee-based charges for access to the resources, long term leases with MSAs to network transport service providers, and other commercial forms of re-imbursement to an relay EDV or other suppliers of the components of the enabled platform (i.e. shared Wi-Fi access points), for enabling complimentary capabilities for an end-point EDV. Further the forms of re-imbursement may include assignment of points for contributions by individual users of EDVs of their device resources to be used as part of the enabled platform that may be subsequently exchanged by the individual users for other goods and services or money. Further, the clearing platform may charge for access to an EDV, or any of the independent capabilities of a device, on a fixed, or metered, subscription basis, with recurring payments to a device's owner over the device's lifetime. Further, re-imbursement may be levied on the end-point EDV accessing enabled capabilities or on a content or application provider that is using the enabled platform to serve an end-point device, and may be remunerated in part to an relay EDV user, whose device is providing enabling capabilities or to any other party in the supply chain that's contributing or facilitating the use or the distribution of the Multipass platform.

As is common in clearing platforms, EDVs may perform peering and netting of transaction charges. An EDV may use the enabled platform as an end-point EDV, incurring usage debits, as well as a relay EDV, accumulating usage credits. A transactional debit and credit system may be used along with a bucket system, permitting an EDV to use the enabled platform for own benefit up to some set limit, with limited flexibly adjusting per the amount of dollar credit allowed or usage credit accumulated. Further, multiple forms of clearing charges may exist, inclusive of monetary fees, reciprocal usage credits or sharing requirements based on volumes and access to preferred resources, and resource access throttling, where access to resources may get opened up and restricted depending on the level of reciprocity in past or current transactions by a given EDV.

EDVs may further be configured with a clearinghouse interface to configure and customize the commercial rates for access to an EDV, the configuration augmenting the other pre-conditions for the EDV. The clearinghouse interface allows users to set the charges they may levy on other peers for using their devices, including by linking charges to the levels of pre-conditions set for devices, and to track the charges associated with the interchanges. The clearinghouse platform may also embed commercial/network terms as part of the enabled platform, so that user applications and vertical services may develop functionality trading off access to, and use of, enabled capabilities depending on the levels of commercial terms, and the commercial terms for EDVs may be set dependent on the levels of demand for their devices' enabled capabilities. As one example, the clearing platform may become a marketplace for complimentary mobile bandwidth. Furthermore, the clearinghouse platform may be used to optimize access to type of, or quantity of, select demanded enabled capabilities contingent on their price, set pricing in response to demand spikes, and otherwise trade of use of commercial terms and all of the other resources.

Furthermore, other network management systems and clearing platforms may be developed as alternative vertical services, developed separately by other, third parties, and may manage the flows of network interchanges and clearing of commerce over the enabled platform in a unique fashion, to enable a specific user application or other process accessing the enabled platform to perform specifically better, monitor a custom group of EDVs only, or for another purposes. As an example, select sub-networks, including enterprises and other specialty groups, may choose to procure, and become service providers for only their sub-networks using, the network management system and clearing platform described, or may develop their own version of a network management system and clearing platform to manage and administer their own sub-networks independently.

### Network Access

A series of devices may be allowed to access wide-area connectivity at a faster rate by accessing it through multiple proximate EDVs and sharing it via short-range interactions, while expanding only marginally more resources. For example, in one geographic location one device may use the other to download a data set, expanding a small fraction of own resources and a greater fraction of another device's resource. In another location, this condition may reciprocate. EDVs may use inter-carrier roaming or inter-carrier geographic signal coverage, without the need to be equipped with the other carriers' wide-area communications capabilities.

Further an end-point EDV may be configured to use different relay EDVs for different purposes, depending on the relay EDV's available resources and capabilities. As an example, a user making a video call may route the voice component of the call through relay EDV equipped for GPRS connectivity, while a relay EDV connected to a Wi-Fi WAP may be used to carry the multimedia component of the call. Software-handover may also be performed, allowing a user to interface EDVs through one set of relay EDVs for access to one set of select wide-area networks and functionality, then interface through other relay devices for access to another set of select wide-area networks and functionality, and then automatically switch to the other communication networks capabilities and functionalities.

### Base Principle

In one embodiment, parallel or pseudo-parallel, proximate computing in a wireless-enabled environment is performed. Proximate computing may use robust short-range interfaces to execute throughput and other functions. A transmission stream intended from a network source (i.e. content server) to a destination EDV may be segmented for routing; some of the segments may be routed directly to the destination EDV through the wireless access network. Other segments may be routed to proximate EDVs through their respective wireless access networks, and then relayed to the destination EDV using short-range links. This process may be reversed for transmission if the EDV is acting as a source to a network destination such as a content server.

The embodiments described herein may use a plurality of radios embedded in user devices to substantially increase the total throughput that may be accommodated in a proximate geographic area at a given time. Each radio may establish a radio frequency (RF) link, with the capability of the link characterized by the antenna and the Power Amplifier (PA) of each device and network access point used to establish the link and by their environment. The combination of radio links may be supported within a proximate geographic area simultaneously for a higher total link bandwidth, and throughput, up to a certain limit, which is driven by a number of factors relating to network links (including availability of accessible network radios and spectrum), short-range links, and device processing.

If there is a destination EDV and C other proximate EDVs, each with two embedded radios, one for wide-area link and one for short-range link, the total data transmission W may be split into C+1 equally sized data segments at the network source. The data segments may be transmitted between network access points and EDVs using uniform parallel network access links with Y kbps of throughput, to each of the destination and C other proximate devices, and data segments, except for the one directed to the destination EDV, may be relayed using the short-range link with uniform X kbps of throughput, in one instance on a multiple-access basis, from each of the other proximate devices to the destination EDV. The combined theoretical throughput A may be represented by:

A=MIN((X+Y),Y×(1+C))

Additional parameters may revise throughput A. W may be split up according to the optimal performance of each link against the prioritization criteria. Further, the Y bandwidth may be different to the destination EDV and each of the C other proximate EDVs and further vary at least somewhat inversely proportionally to C for each device, depending on the number of network access point radios serving the C+1 devices and on the signal strength and interference generated within the wide-area spectral operating environment. The X bandwidth may also be different to each of the C other proximate EDVs and further vary at least somewhat inversely proportional to C for each device, depending on their signal strength to the destination EDV and on the interference generated by the C devices to each other within the short-range spectral operating environment.

In pseudo-parallelism, short-range links are configured into multiple-access schemes between a master and a number of slave devices, and are sequentially or in parallel served by the master to each other. However, irrespective of the scheme, the relative advantage of the short-range link vs. the links to network access points creates the perception that the data transmissions using links are delivered in parallel to each other and to the network link. Links to network access points are not in all instances parallel and in instances of using the same network access point radio may be sequential, as network links are equally defined for data transmissions on a multiple-access basis. Pseudo-parallelism across short-range and network links may be used to create a high level of parallelism in throughput, even though the steps may be sequential.

This base principle may be used for performance enhancement of any other computing functions at the EDV, including of any embedded or acquired resources, through parallel access to, and use of, the collective of links of other proximate EDVs in a NearCloud.

### Base Implementation

The aggregated knowledge of all links that are readily accessible by an EDV may be established. Next, an optimization procedure, calculating each links' relative total throughput performance from source to destination, and the other benefits and costs, against prioritization criteria, determines an assignment schedule. A transaction may be split into a number of segments, and the segments may be routed through network access points or EDVs acting as relays all the way between the source and the destination. The segments may be re-assembled at the destination. Finally, to facilitate successful delivery of the collection of segments, any lost segments parts thereof may then be re-transmitted. A database of available resources may be generated and updated at a predetermined interval.

### Dynamic Resource Allocation

Neaverse is further configured to dynamically allocate resources of the cloud. This not only includes dynamically adjusting the paths by which data may travel, the windows in which the data may travel over the path may also be dynamically adjusted. This is accomplished by use of an optimization engine. The optimization engine generates a scheduling assignment by which EDV's schedule transmissions and receptions. The optimization is configured to perform reactive methods to optimize transmission flows. The optimization engine comprises a layered separation of traffic awareness, a) congestion b) throughput and path windowing, and c) re-transmission. Focus on parallel simultaneous routing. Further tech proof development on the model for the reactive protocol. This relates to both flow control, and to re-transmission. For example, when data is received, the data is broken into packets which are transmitted over a plurality of paths (e.g. Wi-Fi, Bluetooth, and cellular). The optimization engine may further incorporate requirements for execution of transactions in generating an assignment schedule for each association.

The optimization engine stores a map including the possible paths. This includes “broken paths” where, for example, an intermediate node (including hotspots, the network, or other EDVs) may assist in transmission of data. Each node on the map has its own enhanced IP address. An enhanced IP routing table is generated based on the IP address of each node and the proximity and mobility of each device. Additionally, each node on the broken path may have its own transmission characteristics including speed and reliability, these characteristics may be measured by the EDV. Alternatively, if the node is an EDV, the information may be signaled to the optimization engine.

After determining generating the enhanced IP routing table performance measurements are estimated and stored for each path. Based on these performance measurements, a throughput window or a congestion window (CGWD) is determined for each path. The algorithms used to determine the congestions window may be preconfigured or may be signaled from the network. The performance measurements are updated periodically and in response to any triggers (e.g. mobility of EVD's entering or leaving an area). Accordingly, the CGWD is dynamically updated based on the measurements. The scheduling assignment is then generated based on the enhanced IP routing table and the CGWD. Therefore the optimization engine generates a matrix with the CGWD and the proximity to determine a scheduling assignment. Additional parameters may also be included in the scheduling assignment, including path reliability, the priority class of a requesting application or EVD or other features.

Another feature of Nearverse is dynamic window sizing for each path. As a part of the optimization engine, the congestion and reliability of each path is tracked. As packets are transferred over the assigned link, the transmitting device (or central server) may receive ACKs that the packet has been received. If a large number of ACKs are received over a given path, the path is considered to be reliable and the window size may be increased. Conversely, if fewer ACKS than expected are received the window size may be reduced. However, NearVerse may enlarge the window for another path or multiple paths to maintain a predetermined QoS or flow speed.

Because the scheduling assignment is dynamic, packets are sent over the best available path. Retransmission is association based instead of path based. Accordingly, retransmission of lost packets may be transmitted over a different path within the same association.

The optimization engine may also be configured to perform group specialization and optimization of workflow in a NearCloud. Some devices may work in a group in a localized setting using short-range wireless. The optimization engine can use the unique advantages of each device over another device to adjust the scheduling. Certain devices may be set to receive a broader traffic load, and others may be set to perform more of a computing load, and yet another that has a capability enabled, executing that activity for the group—TV broadcasting, 4G connectivity.

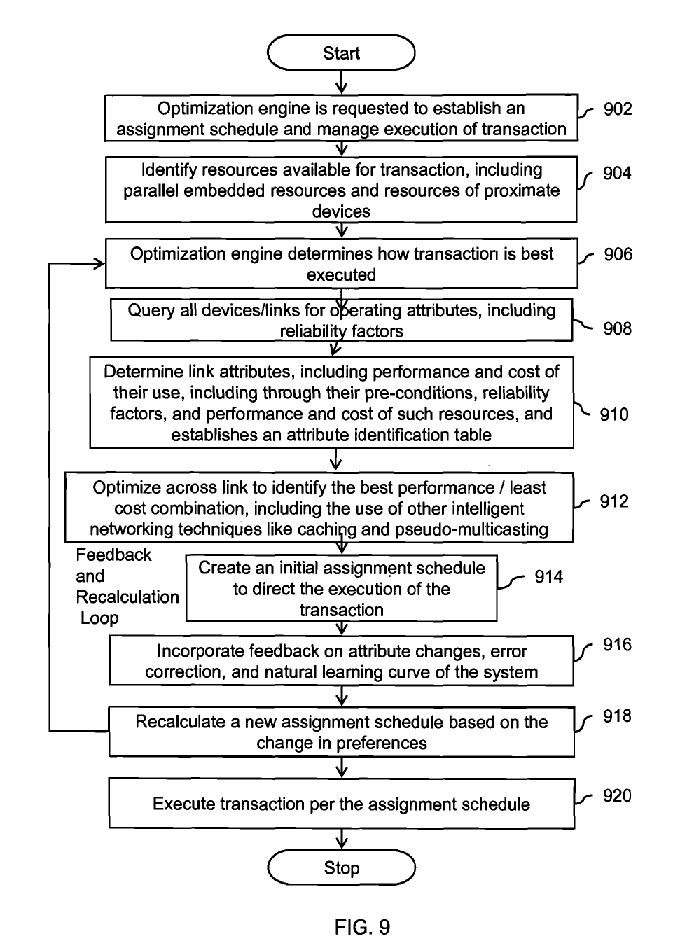

FIG. 9 shows a flow diagram for an optimization process. The optimization engine may receive a request to establish an assignment schedule and manage execution of a transaction 902. The optimization engine defines the available paths 904. The optimization engine then determines instructions for executing each transaction 906, starting with the optimization engine querying a database for the reliability factors of each link and device 908. The reliability factor captures the attributes of each link and device, on determined parameters, and on the level of mobility. The reliability factor is further updated with the results of the attribute identification function, including the feedback on, and score against historical value of, its performance. The reliability factor further has a certain probability distribution.

The optimization engine determines the attributes for each link and device using real-time factors and factors including pre-conditions, reliability factors, and performance and cost of resources, and establishes an attribute identification table 910. The engine then optimizes across the collection of links and devices to identify the best performance/least cost set of links and devices to carry out the transaction, including by using other intelligent networking techniques like caching and pseudo-multicasting 912. The optimization engine creates an initial assignment schedule to direct the execution of the transaction 914. The optimization may then incorporate feedback based on attribute changes, error correction and other feedback techniques 916. Based on the feedback, the optimization engine may iterate through steps 906 through 916 to identify a revised assignment schedule 918. The transaction is then executed by the links and devices according to the assignment schedule 920.

For data distribution optimization, link attributes such as the network and short-range link bandwidth may be calculated based on the input from the reliability factor and may be augmented by a dynamic calculation method, including from the network resource controller or from the device's bandwidth or network conditions indication (i.e. Signal-to-Noise Ratio or Signal-to-Interference-plus-Noise Ratio), and may be further predicted based on device's wireless carrier, its radio and computing characteristics, and its geography and time, by comparing these factors against the typical performance. The calculations may be adjusted based on the number of total parallel network links used in a transaction per a carrier/network access point radio (for network links) and per channel or short-range access radio (for short-range links), and the overall degradation that is typical for such conditions.

The link calculations may be further adjusted based on the penalties associated with the additional processing and other overhead associated with a multi-nodal use of the NearCloud. The dedicated carrier link to a device is assumed as an existing, best-of-breed implementation within a device/carrier network, and each incremental link through the NearCloud carries losses for data segmentation, the relay of the data, and the final re-assembly of the data, and the mobility of each EDV underlying the link.

The other factors added for each NearCloud link calculation may include resource consumption costs and consumer preferences. Resource costs may comprise the cost of use of an EDV's links, inclusive of its carrier/non-carrier access price plan and cost of bandwidth, and the marginal cost of use given its pre-conditions on battery, throughput, and other resource drain that are configured for device's links. Further factors may address shared use of non-carrier/consumer resources and consumers' selection of pre-conditions that address security of data transmission, security of their resource, etc. The cost of bandwidth inputs are derived from the MultiPass clearinghouse engine, while the other resource consumption costs and consumer preferences may be derived from MultiPass pre-conditions.

In addition to link attribute identification, the attributes of all resources, for data distribution or for any other performance enhancement transactions are identified using similar methods of absolute and comparative attribute value identification, with adjustments due to the additional dynamicity and processing, and the resource consumption and consumer costs for each resource are also covered.

Attributes may also be calculated based on the knowledge or predictions for their states, as well as the knowledge or predictions for the changes in their states. For instance, the optimization engine may simultaneously perform multiple transactions; accordingly, the anticipated changes of the states due to other contending transactions may be identified. Further, the optimization engine may collect actual performance data derived during the performance of a transaction, adjust its attribute identification process with additional know-how obtained by comparing predicted and actual performance data, and re-calculate the attributes for each link.

The superset of these attributes may stored in table entries for each link, with each link then having attributed A, B, C . . . Z as their qualifier, and table entries may be updated as often as necessary. The superset of the links may then be captured in a comprehensive attribute database.

In one embodiment, attributes for independent links may be further processed using an additional set of algorithms to identify the attributes for nested and multi-hop links, to capture the complete set of mutually exclusive links available from source to destination and of each of their superset of attributes in the attribute database. Additionally, to the extent that the optimization incorporates use of other third-party links, they are equally inventoried and captured in the attribute database, separately and as part of the nested, source-to-destination sets.

The optimization algorithms may then be applied against attribute sets to establish an assignment schedule, which when completed defines the plan for handling a transaction, using the assortment of links, to achieve the optimal performance for the transaction.

Optimization may include a number of leading optimization approaches inclusive of linear, quadratic, dynamic programming, simulation, and scenario analysis. In one embodiment, the optimization algorithm may be a simple proactive algorithm and is a pre-determined equation which establishes an assignment schedule heuristically.

In another embodiment, the optimization algorithm may be a complex proactive algorithm, which optimizes across the attribute sets according to a set of prioritization equations to establish an assignment schedule (i.e. for data distribution, weights each link for each performance and cost attribute, from source to destination, sets up equations which calculate total performance, total cost, and other constraints given the assortment of links, and then optimizes across constraints by trading-off fulfillment of one constraint vs. another per a set equation).

In yet another embodiment, the optimization algorithm may be a complex, reactive algorithm that starts with a pre-determined equation for the assignment schedule, and then optimizes the schedule based on the instantaneous contribution to performance and cost that is achieved from each link. If a link is constrained and costly, the algorithm readjusts the schedule to direct more of the flow away from the link and toward the links that are less constrained and less costly, and iterates through the set of links evaluated.

Optimization may be subject to a continuous and iterative process of optimization. As the attributes of the links are refined during a transaction, the assignment schedule is also refined, while the optimization techniques themselves may be refined as well. A feedback loop is provided along with a constant refinement of the optimization function and the assignment schedule, which includes static adjustments and more dynamic, intelligent learning techniques, which further enhance performance by improving the selection of paths, adjusting the data segment length, upon receiving updated feedback on the performance of the system or the execution of an individual transaction. The intelligent feedback mechanism for the optimization process may include collecting feedback on the performance of optimization, including scoring performance against expectation, and makes optimization a continuous, self-healing process.

Once the optimization process is performed, the resultant assignment schedule provides instructions executing a transaction across all links, inclusive of multi-hop/nested paths from source to destination, intelligent networking methods, and other third-party links. The assignment schedule also identifies the sequence and timing of execution, and identifies the necessary steps to achieve optimal results including optimal segmentation of the transaction into data (or execution segments) across the optimal set of links, precise instructions for the optimal delivery and execution of the data, re-assembly of data, error correction across any lost segments, and any further functions that need to be performed along the way of each segment from the source to destination. The optimization process also identifies the expected and actual performance of optimization, including the achieved efficiencies in parallel processing to improve time-to-execution and in reduced network load from use of the intelligent networking techniques.

The optimization process also accounts for the optimal ingress and egress points for the execution of the transaction taking into account the links that are situated at or between two EDVs and/or in-network nodes, and are inside the enabled flow paths versus the ones that are situated outside of the enabled flow paths. As such, the optimization process incorporates into the assignment schedule the assignments that are performed per standard network practices vs. the ones that are performed per the procedures described herein.

The assignment schedule may further be established taking into account a given transaction's requirements on latency, quality of service, persistency of flow, and other requirements, or may be established more generally for the execution of any number of disparate transactions, with instructions on the optimal set of paths for each different data/computation type. Optimization mechanism may address the differences in requirements of different data streams and applications, inclusive of live, streaming, and on-demand video, gaming, location-based services, etc, across their varying sets of delivery and computation parameters. Optimization considerations may extend to a transaction's media/application type, the specific functionalities desired to be accentuated by it, or even the types of situations it is used. Further, the optimization engine accounts for the specializations of the superset of links and their abilities to address transaction requirements in an optimal fashion. For instance, the initial portion of a streaming live video may be best delivered using more of the direct wide-area carrier link to the destination EDV, while having the subsequent portions delivered to a greater extent using NearCloud links, when the volatility in their ability to deliver is more tolerated. As another example, the processing for a gaming application may be best performed using the collection of the device's and NearCloud resources, in the cases when the device may not connect using Wi-Fi to a Wi-Fi access point and instead has only a dedicated carrier link to use in addition to the NearCloud. At the same time, the processing of the application may be best performed via the Internet cloud resources entirely, when the device may access the Internet using a robust Wi-Fi access point.

Accordingly, the optimization engine also may configured to account for the granularity in transaction requirements and in the specializations of the links to address requirements, across the entire attribute identification, optimization, and assignment scheduling process. Further, to accommodate granular flow control in execution of the transaction, the optimization engine accounts for the required granularity in transmission and relays of segments, including the minimum and maximum bit size batches of segments that are passed through the relay devices/in-network nodes, and the timing of the relay for each bit size batch. The engine may also account for other flow control techniques inclusive of caching and buffering, to delay transmission and relay of the specific segments to be consistent with the assignment schedule. For instance, flow control may be implemented if the short-range interface between the relay EDVs and the EDV that is the destination is limited to a fixed number of simultaneous sessions, and flow control is essential to optimally switch from delivery of a segment from one relay device to delivery of another segment from another relay device (and the registration, de-registration, and other provisioning steps that are required to carry out delivery over the short-range interface) while accounting for performance degradation that results from switching.

Further, segmentation may be optimized to best fit the available data paths or data paths may be optimized to best fit the desired segmentation. Segmentation may also be performed at the TCP/IP layer, but or other layers depending on optimization requirements for the transaction. Other optimization techniques may segment a transaction and then execute intelligent networking processes, and then deliver and compute the segments in their already processed form.

Overall, the methods described herein may be performed at one or a collection of EDVs, at in-network nodes, or at any other network node or network server, or some combination of the foregoing. The optimization engine at any one point may coordinate with the optimization/routing engines at all other points, and may deliver the assignment schedule to other points. Further, given the computation load associated with some of the optimization techniques, an optimization of the actual optimization process, including across the complexity of the computation, or of certain parts of the computation, the level of optimization desired for a transaction, and the set of device and network links available to carry out the optimization, may further yield an allocation of the actual optimization computation tasks across the devices, nodes, and servers described herein.

### Data Segmentation and Network Routing

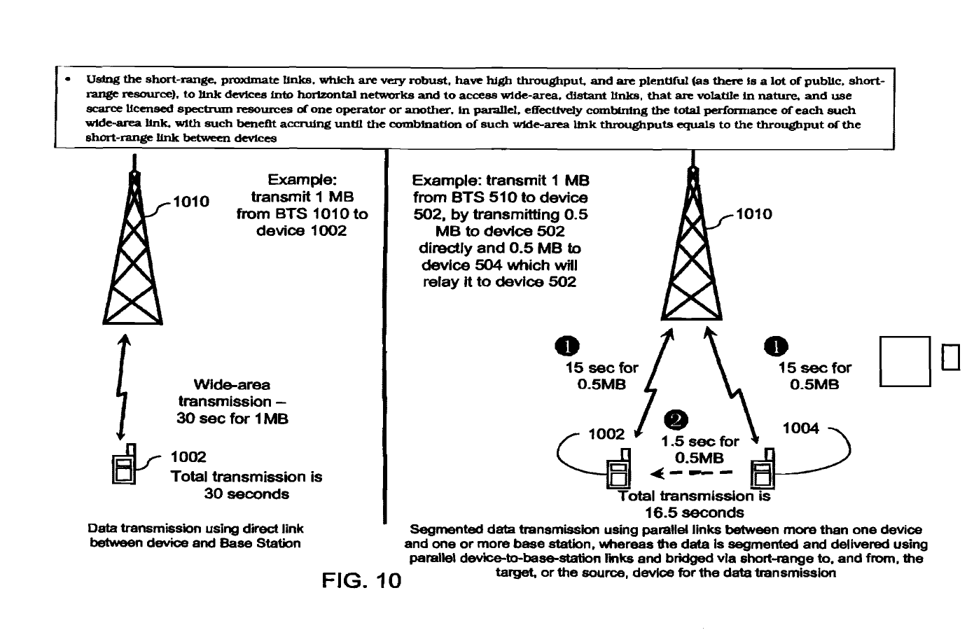

FIG. 10 shows an implementation of a base system described herein, whereas delivery of a given transaction is enhanced using parallel wide-area links to, and short-range proximate links between, two EDVs, and data segmentation between devices. The system includes a BTS 1010 and multiple devices (1002, 1004).

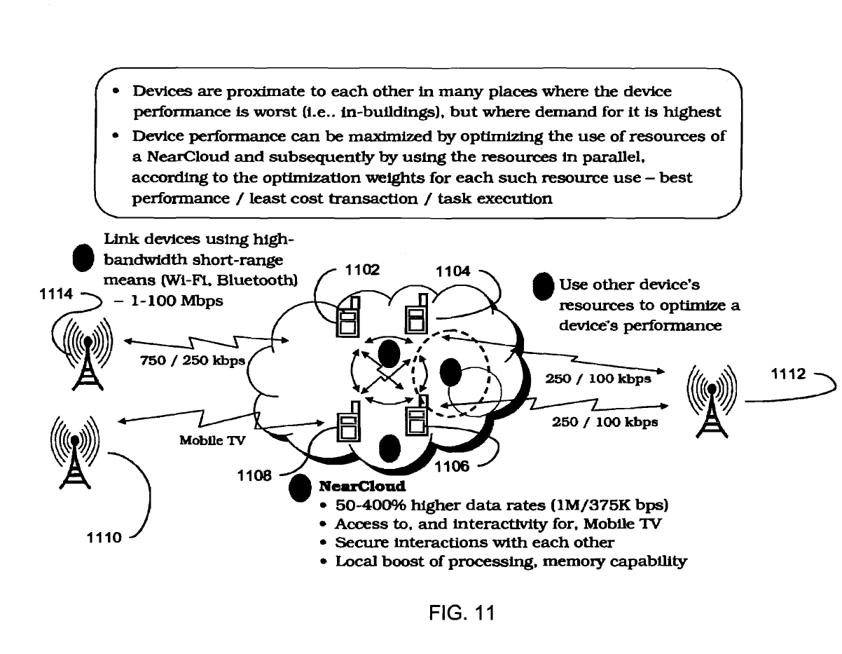

FIG. 11 shows a system for creating a NearCloud, and its implementation using proximate links as shown in FIG. 5. The Nearcloud includes EDVs (1102, 1104, 1106, and 1108) in communication with BTS (1110, 1112, 1114).

Execution of the instructions of the assignment schedule is described in detail hereafter. The segmentation of the transaction, the delivery and execution of the segments, and the subsequent re-assembly of the segments, are all directed according to the assignment schedule. This section also addresses the notion of interim sources and interim destinations acting as surrogates for the final sources and destinations of a transaction, with optimization across links and the segmentation, computation and delivery, and re-assembly of data assignments, taking place across the sources and destinations and their surrogates.

It is assumed that the EDVs are woken up, registered to each other, and are prepared to carry-out the directed transactions, and are directed to do so in a configuration that follows the instructions of the assignment schedule.

In one embodiment, the source and the destination are either in-network nodes or are EDVs. When the source is prompted, or is directed, to distribute data to destination, the data transmission is segmented. The segments are directed to their first range of destinations using the IP addresses corresponding to the in-network nodes or EDVs that are connected to the source through the first range of links, some destinations as final destination and some as interim destinations. This IP address may be an IP address that is modified to reflect the proximity of the device. Accordingly, similar to the optimization engine, the IP address is dynamically adjusted based on this proximity. The EDVs or in-network nodes that are the final destinations through direct links to the source (i.e. that are either connected to the source via direct links or via nested links where the relay points are not enabled, and data is routed according to the standard network practices for such links, but where the first set of EDVs or in-network nodes for such links are the final destinations) receive and re-assemble or temporarily store such segments, according to the assignment schedule. The EDVs and in-network nodes that are not final destinations (i.e. that need to further relay the segments on their way to the ultimate destination) become the interim sources for the second range of destinations, and the remaining segments are then directed to the IP addresses corresponding to the in-network nodes or EDVs that are connected to such interim sources through the second range of links. The number of such interim sub-processes may reflect the number of in-network relay nodes within the core or edge network, and the EDVs in the NearClouds (i.e. single-hop or multi-hop NearCloud links). This process may be iterated until all of the segments are assembled at their ultimate destination. The assignment schedule may identify all links, sources and destinations, inclusive of the interim ones. The nested links that have interim relay points, that are not enabled, may be treated as direct links between two EDVs and/or in-network nodes, since traffic flows through such relay points is performed per standard network practices.

The routing engine may follow the assignment schedule for each link according to the desired configuration and sequencing, but at the same time, executing the assignment for each set of instructions in the optimal manner. For instance, as the bits of a segment arrive at one interim destination point, they are continuously re-directed to the next interim destination point, as long as consistent with the assignment schedule. Similarly, the bits and segments are re-assembled at the ultimate destination per the assignment schedule and not necessarily at the time that the collection of segments is delivered to such destination. On the other hand, the routing engine similarly executes flow control per the assignment schedule. This may include executing instruction to temporarily buffer select bits of a segment, in order for such bits to be distributed to the next interim destination EDV, but in sequence to some other segment transmission that is instructed to be performed in advance.

In fact granularity of process is an important principle, depending on the requirements of a transaction (i.e. if the transaction is a time sensitive, live video, where delivery of individual bits in sequence is important, with such live video streamed between the content server and the destination device and consumed by the destination device application as the bits arrive, then the optimization engine selects the configuration and sequence of the segmentation, routing, and re-assembly of the data transmission to optimally fit the requirements of such a transaction, in a way that's potentially different than if the transaction is delivery of a large data file, where the timing of the delivery of the entire file is important and the order of the delivery of the individual bits is less relevant).

In another embodiment, the source and the destination are not in-network nodes or EDVs. In the case of the source not being an in-network node or an EDV, then contingent on a transaction to the destination being an authorized transaction, the request to execute a transaction (i.e. delivering data to the destination) is then delivered to the EDV or in-network node that is identified by the assignment schedule as the node that is optimally situated to become the ingress point for the data from the source, prior to further distribution through in-network nodes or EDVs, and such node is classified as the ingress point. The ingress point then follows the assignment schedule instructions and acts as a proxy for the destination, requesting the source to distribute the desired data to such ingress point, and such distribution is performed according to the standard network practices for such link. Once the data is received at the ingress point, then the data distribution process is performed as though the source and destination are both EDVs, treating the ingress point as the interim source.

If the destination is not an in-network node or an EDV, then for authorized transactions, the assignment schedule may identify in-network nodes that are suggested egress points for the data, following such data being distributed through in-network nodes, and are classified as the egress points. The transaction may be performed from the source to the egress points as the interim destinations, as though the source and destinations are all in-network nodes. In parallel, the source communicates with the destination to relay that the egress points are the new sources for the requested data transaction. In one embodiment, the source informs the destination that the data transaction is segmented and identifies the IP addresses of the egress points that are the new sources for each separate data segment. Once the data segments are received at the egress points, they are then forwarded directly to the final destinations using links to their actual IP addresses. In another embodiment, the source identifies a virtual IP address that is the same for each of the egress points and is the IP address for the ultimate source and informs the destination that the data transaction is segmented and may be delivered in a specific sequence. Once the data segments are received at the egress points, they are then forwarded directly to the final destinations using links to their virtual IP addresses, with such links established and terminated according to the specific sequence in one instance, or established concurrently in another instance. Such transaction may be performed for the set of in-network nodes that are linked to the destination nodes and may in some cases prove immaterial or impractical (i.e. if the optimization yields tangible results in the NearCloud only, but a destination node is a device that is connected only via the dedicated carrier link directly to the carrier network, and the source is a content server, then data distribution may follow the standard network practices for such data distribution from the source to the destination). At the same time, in other cases such transaction may prove very material and practical, especially when the destination is the content server and the source is an EDV.

In the case that both the source and the destination are not in-network nodes or EDVs, then only the interim segments, serving as ingress and egress points, may execute the processes described above for a data distribution transaction, but only to the extent that such data distribution transaction is an authorized transaction.

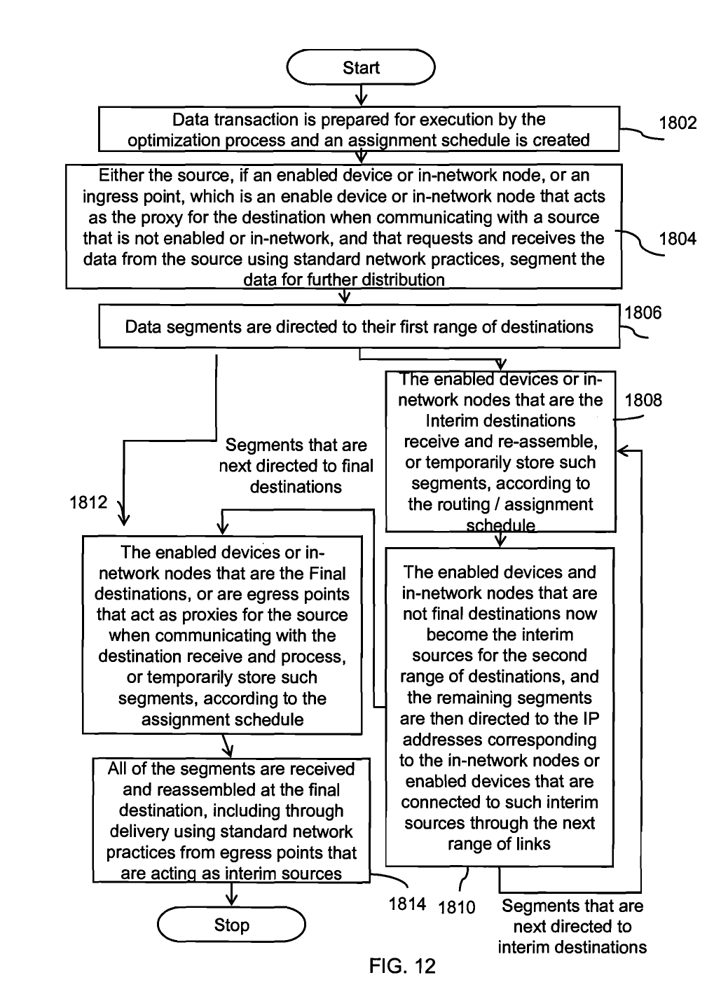

FIG. 12 is a flow diagram for a method of data delivery. A transaction is prepared for execution by the optimization process and an assignment schedule is created (1202). The source, or the ingress point, which is not enabled or in-network and which acts as the proxy for the destination and requests data from the source using standard network practices, segments the data for further distribution (1204). Data segments are directed to their first range of destinations using the IP addresses corresponding to the in-network nodes or EDVs that are connected to the source through a first range of links (1206). EDVs that are interim destinations receive and re-assemble, or temporarily store, such segments according to the assignment schedule (1208). The EDVs and in-network nodes that are not final destinations become interim sources for the second range of destinations, and the segments relayed through them are directed to the IP addresses corresponding to the in-network nodes or EDVs that are connected to such interim sources (1210). Segments that are next directed to interim destinations repeat step (1208). Segments that are directed to final destinations, or egress points that act as proxies for the source when communicating with the destination, are received and re-assembled, or temporarily stored, at such destination (1212). All segments are received and reassembled at the final destination, including through delivery using standard network practices from egress points acting as interim resources (1214).

The baseline scenario is when the source and the destination are in-network nodes or EDVs, and the assignment schedule yields optimal results. At the same time, scenarios when the content server is not an in-network node or an EDV, as a source or destination, but the device is an EDV, as a destination and source respectively, may still be highly desired scenarios. Such scenarios are anticipated to be substantially benefited since the link to content server from any egress point in this situation is expected to be in place. In other scenarios, when a device is not an EDV and is the source for transactions from device to content server, or the destination for transaction from content server to device, there maybe a number of proximate devices to such device that are EDVs.

Similar steps may be performed for other performance enhancement processes, in addition to data distribution, with the key differences being that the source and destination of a transaction may be the same and that the crux of the performance enhancement occurs at the interim destination points where most of the required resource input/processing of the transaction segments takes place, prior to eventual re-assembly of the processed segments into a transaction back at the destination.

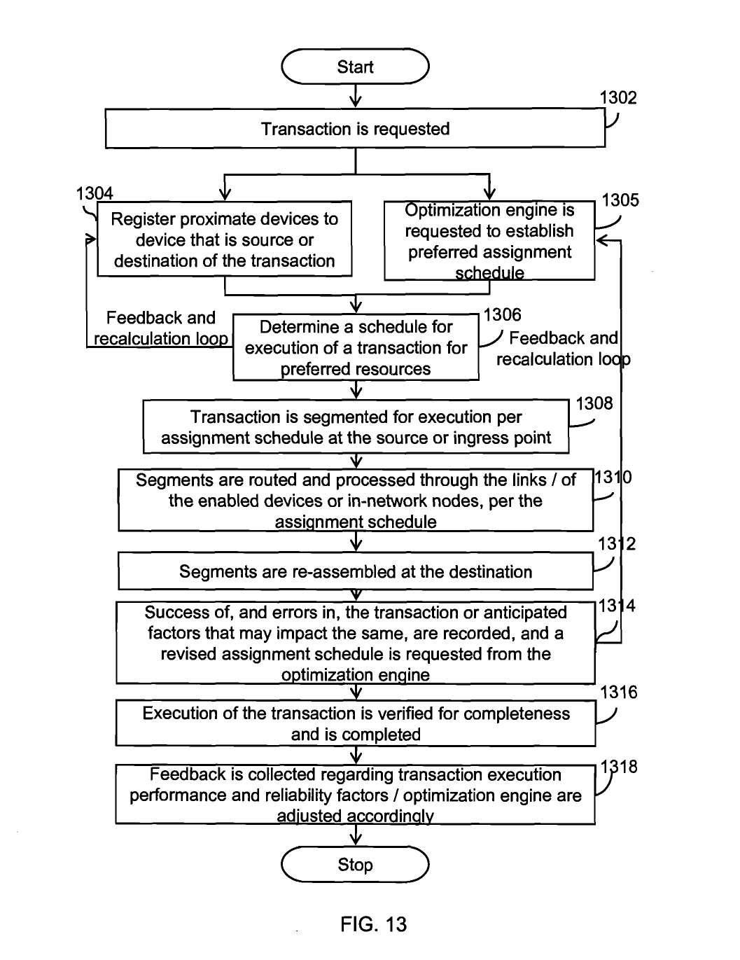

FIG. 13 shows a flow chart for a method for optimization with data segmentation and network routing. A transaction is requested for a selected device (1302). Proximate devices are registered to the selected device (1304). The optimization engine may also be requested to establish a preferred assignment schedule (1305). The schedule of preferred links is determined for execution of the transaction (1306), including potentially altering the set of proximate devices that are registered (1304). The transaction is then segmented for execution per the assignment schedule at the source or ingress point (1308). Segments are routed and processed through the link of the EDVs per the assignment schedule (1310). Segments are re-assembled at the destination (1312). Errors in the transaction execution are recorded and such data is requested to be resent by the optimization engine (1314), including potentially starting with a revised assignment schedule for such data. Execution of the transaction is verified for completeness (1316). Feedback is collected regarding the transaction, and the reliability factors and optimization engine are reconfigured accordingly (1318).

### Error Correction

Each EDV may be configured to actively check for appropriate receipt/execution of the segments of a transaction and for its ability to carry out the segmentation, delivery, computation, and re-assembly of such transaction appropriately. This includes the actual receipt/execution of the segments, as well as the integrity of such segments following their receipt/execution. If an error or inability is identified, instruction is sent to the optimization engine to schedule re-transmission of such lost segments and to re-direct such segments that may not be appropriately processed. The optimization engine then incorporates such feedback, and adjusts the assignment schedule to optimally re-transmit such segments and to re-direct them more appropriately, after which the routing engine delivers such segments from source to destination.

Such errors may occur due to natural inefficiencies in links, due to the failures of links to properly carry out their instructions, and due to the movement of EDVs, which are initially instructed to support required links for a transaction, but that subsequently move out of the scope of NearClouds or that otherwise sustain changes to the links that were initially instructed to be supported. In such instances, it is possible that errors (or inabilities) are actively acknowledged by such EDVs, e.g., when they may anticipate a forthcoming error due to a change in their state (i.e. movement out of NearCloud) or may be detected by the optimization engine as a consequence of timeouts in their execution of their assignments, where following a certain pre-determined or selected time interval, required segmentation, delivery, computation, and re-assembly is not acknowledged as having been accomplished successfully. If the optimization engine observes that the errors and inabilities are persistent, it may choose to eliminate the link responsible for the errors from the assignment schedule.

### Reliability Factor

The reliability factor of an EDV, and the corresponding link, reflects their ability to perform a set of instructions for a transaction. The reliability factor is used by the optimization engine, to refine the attribute identification table, and to calculate the weight and consideration that the optimization engine assigns to such a device within the assignment schedule. Overall, the reliability factor characterizes the devices on a more static basis, allowing the optimization engine to factor in such factor to augment its more dynamic identification of devices' attributes in preparing the assignment schedule.

The reliability factor may have determinants associated with instantaneous reliability, as well as reliability in a situation, and reliability taken over time. The former may be more defined by an EDV's, and correspondingly by the underlying link's inherent characteristics. The second may identify such link's specialization or its marginal advantage, especially in light of circumstances (i.e. effectiveness in supporting a given transaction in a given location or situation). The reliability factor taken over time, in addition to other factors, may also relate to its state of mobility. Mobility is a particularly important part of the reliability factor as the level of mobility for an EDV corresponds to the uncertainty for each link and the level of losses due to incomplete link transactions (i.e. a link breaking up mid-way through delivery of their segment).

Specifically, as the reliability factor may relate to this determinant taken over time, it may capture the overall nature of a device's mobility state, the change in its mobility over time, and its reliability in executing assignments given changes in its mobility state. For instance, an EDV that is identified with a high determinant value for its mobility state may reflect that the device is a stationary Wi-Fi point. Similarly, a high value for the determinant that tracks the change of a device's mobility over time may reflect a device that is very reliable during select time intervals of every day, because it is stationary on a train during such time. Lastly, a high value for its reliability in executing paths given changes in its mobility state may identify a resource that is assigned a very high pre-condition ranking and has a track record of being used over time without as large of a concern of user interruption or transaction termination due to an excessive drain of resources.

At the same time, the instantaneous reliability determinant may relate to the actual specifications of a device, and to the inherent characteristics of its ability to execute a transaction. This includes its anticipated performance based on inherent RF specifications and associated network link (i.e. typical bandwidth), tolerance to parallel utilization and interference, and degradation due to the processing and other overhead associated with its use. This further includes other factors inclusive of its resource costs, including the commercial cost and the marginal cost of use as derived from the pre-conditions settings.

Another cross-section of the reliability factor is a mean value and a certain probability distribution. For instance, a high standard deviation for a reliability factor of a link may define a highly volatile 4G wireless link in the middle of a suburban environment with sparsely deployed wireless infrastructure. Alternatively, such high standard deviation may depict a user that is constantly moving, as opposed to spending most of their time stationary in a location.

Further, such reliability factors may be updated. These updates follow the feedback mechanism employed by the optimization engine, collecting feedback on both the execution of assigned transactions by a device, as well as accounting for the links actual performances against expectations in supporting the intended instruction. Such feedback process allows for a substantially refined reliability factor to be determined over time, so that a device used over a longer timeframe has further inherent reliability, due to the higher certainty in the value of its reliability factor, than another device process that's been more recently enabled.

The reliability factor of an EDV may be captured as multi-determinant factor. In one embodiment, a table entry of determinant categories, with a unique value assigned to each determinant, may characterize the reliability factor of one device. In another embodiment, such table entry is a time-based searchable log of an EDV performance and characteristics, and the reliability factor is assigned based on an algorithmic search of such log. The collective of reliability factors, and determinants, for devices are amassed into a comprehensive database of reliability factors.

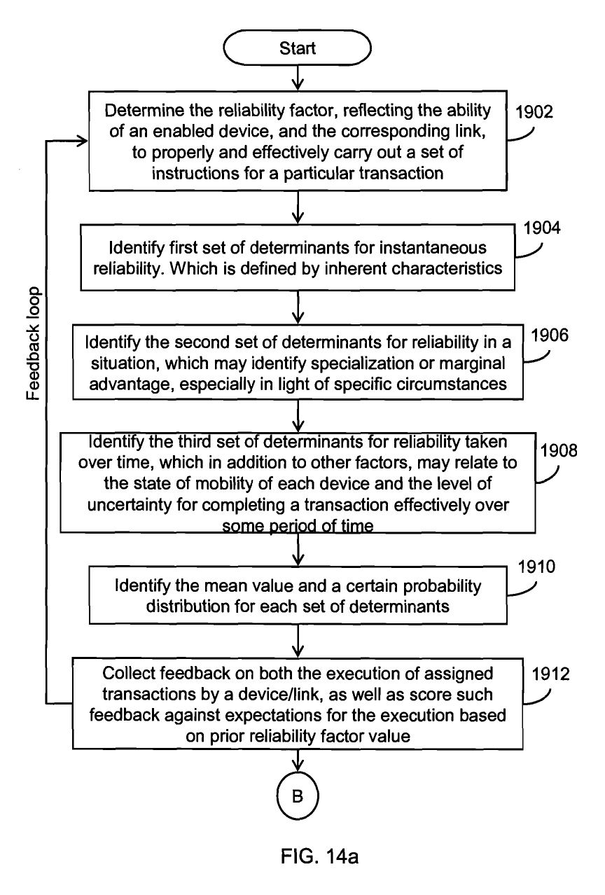

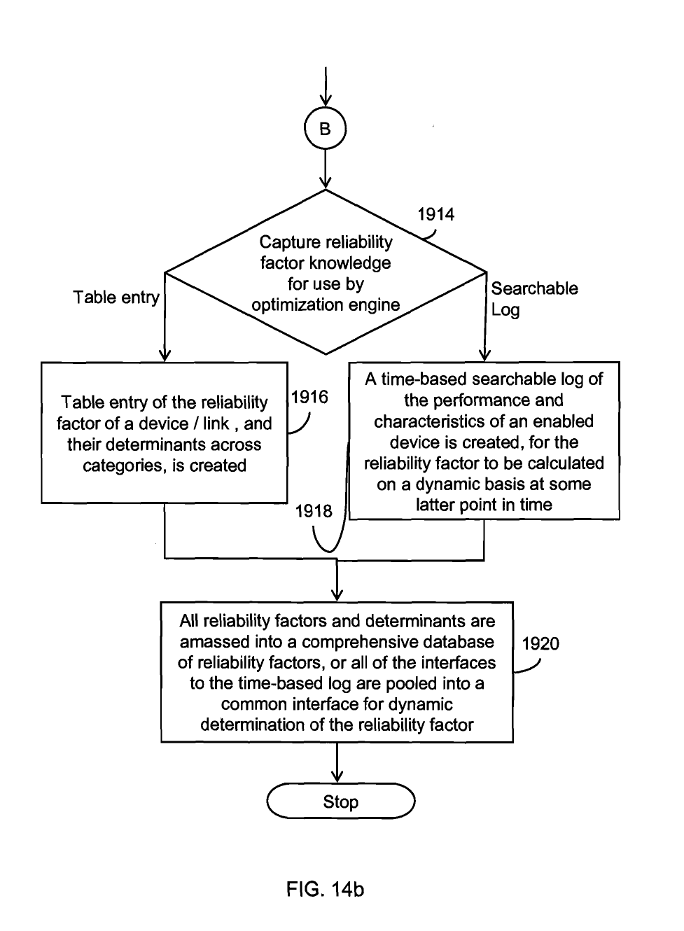

FIGS. 14a and 14b are flow charts for a method of determining reliability factors. An EDV or in-network node may determine a reliability factor (1402). The reliability factor may represent an ability of the EDV and corresponding links to properly perform a given set of instructions for a particular transaction. The device may identify a first set of determinants for instantaneous reliability (1404), which may be determined based on inherent characteristics (i.e. processing speed, wide-area connectivity type, PA and RF characteristics.) The EDV may then identify a second set of determinants for reliability in predetermined circumstances (1406), which may identify specialization (i.e. effectiveness in supporting predetermined transactions, in predetermined locations or situations). A third set of determinates may be identified for reliability measurements over a predetermined time period (1408), which may be based on the state of mobility of each device, level of uncertainty for a device completing a transaction, likelihood of a link failure during a task etc. The EDV may further identify the mean value and certain probability for each set of determinants (1410). The EDV may collect feedback on both the execution of any transactions and score the feedback against any expectations of performance based on the reliability factor (1412). The reliability factor knowledge is then captured and used by the optimization engine (1414). A table entry of the reliability factor of a device/link, and their determinants across all categories is created (1416). A time-based searchable log of the performance and characteristics of an EDV is created, for the reliability factor to be calculated on a dynamic basis at some latter point in time (1418). All reliability factors and determinants are amassed into a comprehensive database of reliability factors, or all of the interfaces to the time-based log are pooled into a common interface for dynamic determination of the reliability factor (1420).

### Example

A request to upload a data file of 1,000 kilobytes to a content server 214 is received from an application on mobile phone 202. Mobile phone 202 accesses the optimization engine to determine the assignment schedule to execute such data upload transaction. The optimization engine identifies a collective set of EDVs and in-network nodes, and corresponding links, which may be used to execute the transaction, yielding EDVs of mobile phone 202 through 206 and of WAP 208, and each of their Wi-Fi links to each other, the wide-area links (i.e. CDMA EV-DO Rev. A) of mobile phone 202 through 206 to BTS 210, and the Internet link of BTS 200 and WAP 208 to the Internet 212. The optimization engine then queries the reliability factor database at the network central server 216 and identifies the set of reliability factors applicable to each such EDV, and their corresponding links. The optimization engine then also identifies the set of attributes for each such EDV and resource, and inventories them into an attribute identification table. The optimization engine then further identifies that links from mobile phone 202 to the BTS 210 to the Internet 212 (nested link 1), and links from mobile phone 202 through mobile phone 204 and through mobile phone 206, and then through BTS 210 respectively, to the Internet 212 (nested link 2 and 3), and from mobile phone 202 to the WAP 208 to the Internet 212 (nested link 4) are the required nested links for the execution of this transaction, and compiles their respective attributes into nested attributes sets.

The optimization engine may then use a complex proactive algorithm to identify the appropriate combination of links to use for the transmission of the data file. Specifically, it confirms the weighted average of the mobility determinant for the reliability factor of each link and the net bandwidth for each link 1 through 4, sets up equations that calculate the total net transmission time for a file of a reference size (i.e. 100 kilobytes) for each such link, the total net costs for the use of each such link, and sets up an equation for calculating an optimized set of weights for each such link based on their contribution to performance and cost of the transaction. The optimization engine then runs a linear program against the set of equations identified above and identifies that 300 kilobytes (segment 1) of the transmission may be assigned to link 1, 200 kilobytes to each of link 2 and 3 (segment 2 and 3 respectively), and 300 kilobytes to nested link 4 (segment 4), and that segment 1 may be relayed in parallel to relay of segment 2, 3, and 4, and that segment 2 may be relayed first, followed by segment 3, followed by segment 4, and that the segments may be in turn split up into bit batches of 100 bits each. The optimization engine then packages such identified results into the assignment schedule.

Mobile phone 202 is in parallel registered to mobile phone 204 and 206 and WAP 208 using its Wi-Fi link, per MultiPass platform. Referencing the assignment schedule, mobile phone 202 then proceeds to segment the data upload into the four identified parts, and informs the source that the data transmission may come in four segments, each from mobile phone 202, 204, 206, and WAP 208, and also informs of each EDV's IP address. Mobile phone 202 then relays segment 1 using its wide-area link to BTS 210. In parallel, mobile phone 202 first relays the first bit batch of segment 2 to mobile phone 204, that of segment 3 to mobile phone 206, and that of segment 4 to WAP 208. Upon receipt of the first bit batch of segment 2, mobile phone 204 proceeds to relay the bit batch to BTS 210, and mobile phone 206 and WAP 208 similarly proceed to relay their respective bit batches, as they come in, to BTS 210 and Internet 212 respectively. Upon receipt of each bit batch of segment 1, 2, and 3, the BTS 210 then relays the bit batches to Internet 212 per standard network practices, as does the Internet 212 proceed to relay all of the bit batches of each of segment 1,2,3, and 4, in turn to the content server. The content server receives the bit batches labeled with the IP addresses of mobile phone 202, 204, 206, and WAP 208.

Mobile phone 202 proceeds to re-access the optimization engine to assess the performance of each of links 1, 2, 3, and 4, and identifies that mobile phone 206 is moving out of range of the Wi-Fi link to mobile phone 202. The optimization engine re-adjusts the assignment schedule for the remainder of the data upload transaction, of which 500 kilobytes are still not transmitted. Mobile phone 202 proceeds to then to re-segment the not yet transmitted portion of the upload data file in one embodiment, and re-adjusts the segmentation of segments 1, 2, 3, and 4 in another embodiment, and paths the segments according to the revised assignment schedule.

At the same time, as the bits arrive at the content server, it identifies lost bit batches in segment 3 and relays the error correction request to mobile phone 202, in one instantiation, per standard network practices (if exist), and in another, as a response to a query from mobile phone 202 regarding content server's receipt of all of the bit batches. The mobile phone 202 then responds to the error correction request, accesses the optimization engine, identifies the re-adjusted assignment schedule to deliver the lost bits, and proceeds to segment and route the lost bits according to the revised assignment schedule.

The bits are re-assembled at the content server confirming the receipt of the entire 1,000 kilobyte transaction. The mobile phone 202 is able to deliver the packet data stream to content server in a speedier manner than it may have performed using its own wide-area link only.

Mobile phone 202 also relays the transaction log to the network central server 216. The network central server then increases the mobility determinant of the reliability factor for each mobile phone 202, mobile phone 204, and WAP 208, while decreasing the mobility determinant of the reliability factor for mobile phone 206. The network central server then also identifies that the lost bits in segment 3 were due to mobile phone 206 moving away from mobile phone 202 faster than the optimization engine was able to adjust for such move, and proceeds to revise the optimization engine algorithms to more granularly segment the bit batches and resets the time interval specified for re-access of the optimization engine to a shorter duration. The network central server then relays the adjusted optimization engine algorithms to each mobile phone 202, mobile phone 204, mobile phone 206, and WAP 208.

### Intelligent Networking Processes

Intelligent networking processes may streamline performance by using the combination of links. This may include storing and relaying at an EDV (caching) and pseudo multi-casting using short-range links. This may also include process specializations, network coding, intelligent re-combining, context-based optimization. Intelligent networking techniques store and process data at EDVs while using connectivity links to reduce the reliance on the volatile and redundant wide-area links to transmit data and to lower the total wide-area network load.

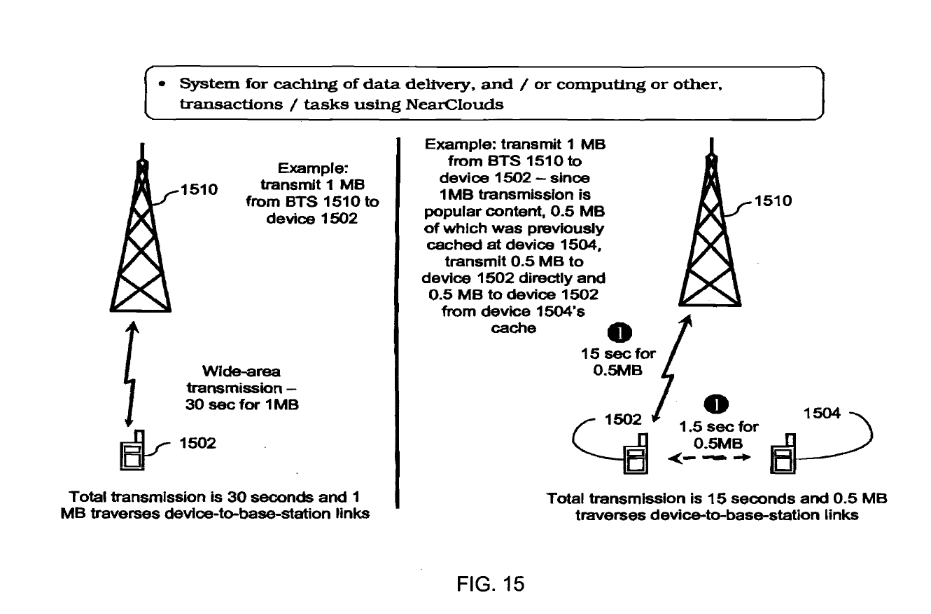

FIG. 15 shows a system for caching of data delivery. The system may include a BTS (1502) and multiple mobile devices (1502, 1504). Content that is accessed frequently may be cached at EDVs for its future relay to other proximate EDVs for their respective consumption additionally, an EDV keep the cached data for its own use. For example, at a football stadium, replay segments of the football game in progress may be accessed and cached by an EDV. The cached content may be accessed by other EDVs at a substantially faster rate then from a central content server. The EDV may be configured to determine whether to store the cached content based on the proximity of other EDVs.

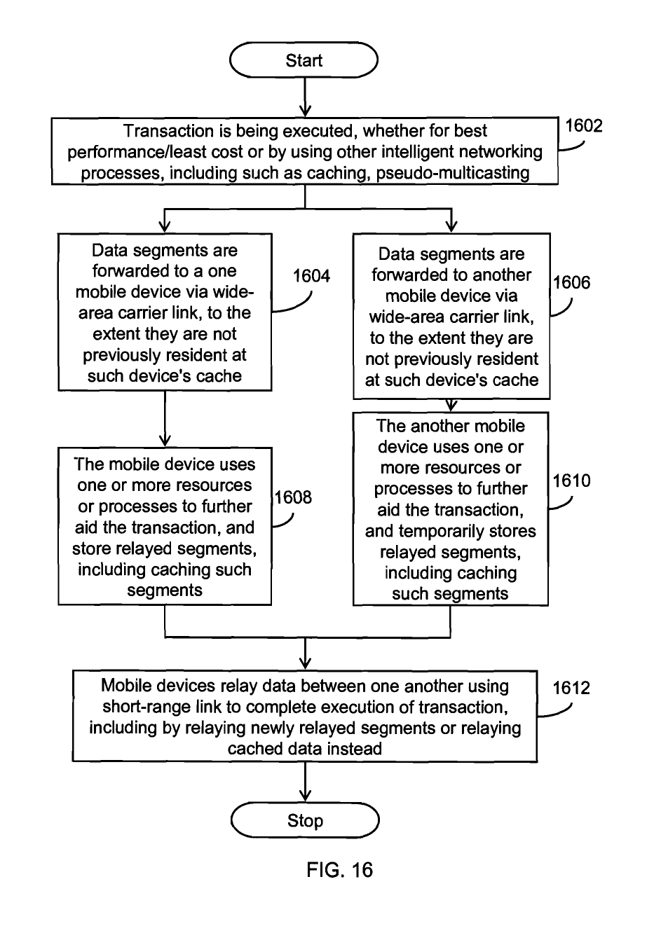

FIG. 16 is a flow diagram for a method of caching. A transaction may be initiated at which time an assessment is made determining a best performance for transmission (1602). Data is forwarded to first mobile device via a wide-area carrier link (1604). Data may also be forwarded to additional mobile devices via the wide-area carrier link (1606). The first mobile device uses resources to aid in the data delivery and temporarily stores relayed segments and caches the segments (1608). The other mobile devices also use resources to further aid in the data delivery and temporarily store relayed segments and cache the segments (1610). The mobile devices then relay data between one another using short-range communications to complete execution of the transaction, e.g. by relaying segments or cached data (1612). Intelligent caching allows the forwarding device to store the data for future use either by the device itself or to forward to other devices. For example in video transmissions, the device may cache the data for use in predictive video algorithms and frame matching to determine a next frame. This may be used to enhance the techniques used with Media-Flo, for example.

Another method of caching includes probabilistic caching, where a portion of content commonly accessed is cached at a certain percentage of devices while the remaining portion of content commonly accessed is cached at a certain other percentage of EDVs that are not caching such first portion of content. This may allow for a larger proportion of commonly accessed content to be cached within sufficient proximity to be accessed by a high proportion of EDVs from each other instead of from a central content server. At the same time, this may preclude excessive replication of such cached content at the EDVs, instead spreading the cache load across a population of EDVs, further taking advantage of the multi-nodal, NearCloud configuration, and the likelihood of an EDV to be in proximity to multiple other EDVs.

This may also further define content caching specialists, whereas content is cached based on the Nearcloud networks set up by an EDV (i.e. a sports enthusiast's device may cache more sports segments due to the substantially higher probability for her to be surrounded by other Eagles fans and for her to lead those around her to watch such replay segments). For social caching networks content is cached based on the probabilities that a certain person is proximate to others that want to consume a certain type of content and that such person may influence such others to consumer a certain type of content.

In the case of caching, the optimization engine may be configured to execute optimization of the system as a whole in addition to executing the assignment schedule for the purpose of a transaction. When a transaction is requested, the optimization engine identifies the overall set of circumstances, inclusive of the EDVs, corresponding links, that are available to be used and that are actually used, and the type of transaction that's being requested, in its transaction log database. It then cross-references if such a transaction is, or previously was, also requested by EDVs in related circumstances, and identifies whether there is an optimization benefit from using the caching process in the future for future tasks and transactions. If caching is beneficial, the optimization engine identifies in its assignment schedule the subset of segments that may be cached at select EDVs. Once the routing engine executes the assignment schedule, the EDVs assigned to cache segments then cache the segments. During subsequent transactions, the optimization engine develops its assignment schedule with instruction for EDVs, which have cached content or are near other EDVs with cached content, to substitute portions of content from the source with that cached content. Portions of the content are transmitted from identified EDVs as interim sources, without transmitting the portions from the ultimate source. The optimization engine also assigns characteristics to the cached content, including a time-out window, after which such cached content becomes stale, or ranks the content according to popularity, so that when a non-cached, more popular portion of content is intended to now be cached, it replaces the less popular content that is already cached at the EDV.

Content may be cached due to a likelihood of re-use by another device. Content being requested by multiple EDVs proximate to each other, may be delivered to one devices, cached at the device, and then relayed to others using short-range links. An even further evolution is when a group of devices are identified requesting a certain portion of content simultaneously, and when an EDV is assigned to relay only one or more data segments that are a subset of the entire portion of content, while other EDVs are assigned to relay the remainder of segments of such content, and such relays of the portion of content are intended for consumption by all of such EDVs. Each device caches the delivered segments, and distributes them to other EDVs. Similarly each EDV receives remaining segments from other nearby devices, and re-assemble the cached segments and the newly received segments into the entire of content.

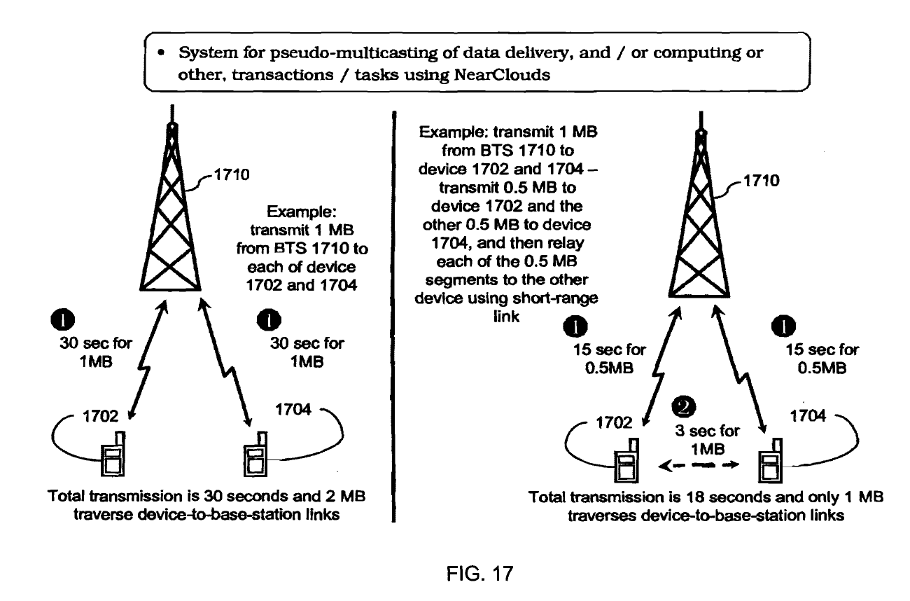

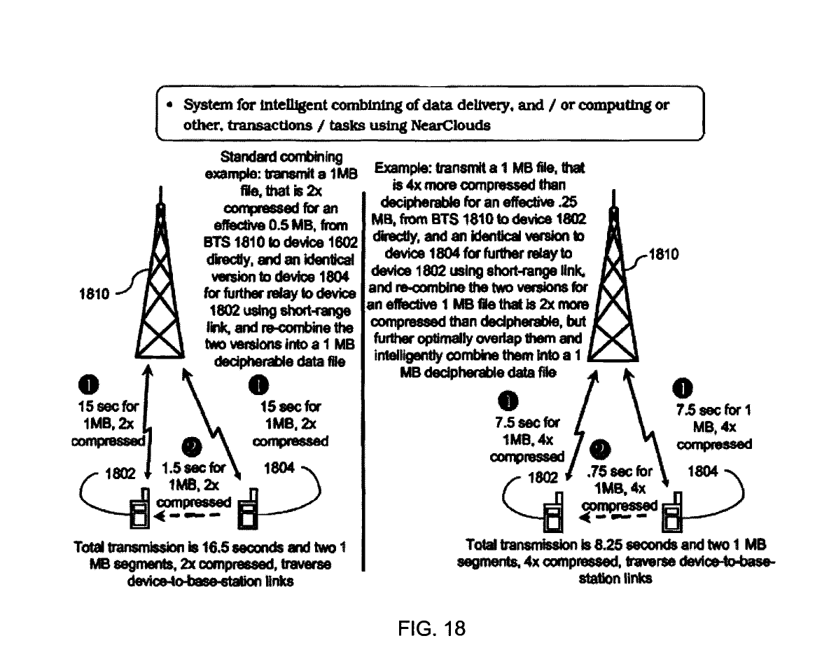

FIG. 17 shows a system for pseudo multi-casting of data. The system includes a BTS 1710 and two EDVs 1702 and 1704. Pseudo multi casting uses short range links by seeding multiple users with a portion of entire transmission. When a predetermined number of EDVs are located within a defined proximity, this may allow the broadcasting of large portions of data while using a reduced portion of cellular bandwidth. Accordingly, in enacting pseudo multi-casting, the multicasting transmitter determines that a predetermined number of users are in the defined area. An algorithm the larger data stream is broken into segments and based on the location of each device and the device attributes, the transmitter selects a map determining which portions of data are initially transmitted to which devices, these devices are termed seed devices. All devices involved in the pseudo multicasting receive a signal indicating that a pseudo multicast transmission is being initiated. The seed devices receive the portions of data and cache the data and forward the data to proximate devices, each proximate device in turn performs the same function. The devices can transmit and receive in parallel. The data is spread around to each user until each device has the complete transmission. This enables the network to transmit streaming content to many users without requiring large amounts of bandwidth. Another embodiment may combine pseudo multi-casting with context awareness (in football stadium, or at home). Accordingly, the network can anticipate large numbers of users will request an instant reply after a controversial call, and thus the data stream is tailored to respond.

An example of pseudo multi-casting is when four EDVs within a NearCloud are all at a venue, attempting to simultaneously download a select live video feed of a football game in progress. The optimization engine identifies that pseudo multi-casting is the best approach to serve these EDVs, splits the live video feed transaction at the content server into four unique segments, and assigns each segment to the respective link to each of the four devices, so that each device is receiving one of the four segments. The routing engine then relays each segment to each of the intended EDVs using their respective wide-area links in parallel to one another, stores each segment at each such device, and then instructs each device to immediately re-transmit a copy of the received bit batches of each such segment to the other three devices using their respective short-range links to each other. As each device receives each of the four segments' bit batches, with one via its wide-area link and three via its short-range link to the other three devices, it re-assembles such bit batches, effectively receiving the complete stream. Every wide-area link used is directed to transmit exactly one fourth of the live video feed content that it may have had to transmit absent this approach, as it may have to have transmitted the complete live video feed to each of the four devices.

Depending on multi-hop architectures and further short-range transmission intelligence, as far as the optimal number of segments and sequence of the short-range transmission within the NearCloud, such pseudo multi-casting approach may also extend to cover a broader population set. In some instances, some EDVs purely rely on short-range links to receive the content, while having other EDVs acting as super nodes, being the surrogates for access to network access points to receive required data segments.

Additional process optimization may comprise specializing EDVs' links. The more volatile wide-area links, which are also the most seamlessly available links, may be used for all of the control data of a transaction (i.e. signaling and error correction notifications), while the broader unified delivery architecture is used to deliver the actual data transaction. This principle may be extended to the broader number of steps of the actual transaction, with further optimization around the preponderance of a process load that a device and its links may handle, versus those of another such device.

In the case of multi-hop architectures, the principle of Nearcloud network coding is another intelligent networking process. Network coding reduces the number of re-transmission segments required to carry the data to the destination.

Intelligent networking processes may include combining and re-combining of content. In addition to maintaining select portions of content cached, and pseudo-multicasting such content, another process may be to actually package the data according to the knowledge that it may be segmented and re-assembled during its delivery according to a certain sequence. Potential techniques resemble some of the advancements achieved at the signal processing level with intelligent combining, where two antennas may deliver two sets of identical signals to a device using power each, although orthogonally shifted in some parameter such as phase. Once received, such two identical signals are re-combined at the device, and in addition to generating the equivalent of the sum of the two signals in power density, the phase offsets facilitate additional intelligent combining advantages, boosting the signal to a level that is beyond what one antenna may have produced using the full power by itself. Here, the same approaches may be applied to content processing.

FIG. 18 shows a system for intelligent combining of data delivery. The system may comprise a BTS 1810 and multiple mobile devices (1802, 1804). Data transmissions may be formatted to a level that is more compressed than the level that may be deciphered by one device, and then sent in parallel to two different EDVs, with any further relay to the destination device via the short-range link between the two devices. When recombined at the destination EDV, the combination of the segments may represent a data transmission that is 2× more compressed or formatted then may be decipherable, but in fact may then further be optimally overlapped and intelligently combined across the orthogonal offsets, including through the use of a key that links the two segments orthogonally, and as a result represents a data transmission that is deciphered by the destination device as though such device received the properly compressed or formatted data transmission.

Other intelligent networking processes may be designed to take advantage of the knowledge of context to optimize communications. For instance, knowledge of the types of users, applications, and other preferences in the NearCloud, may prompt the optimization engine to push down specifically selected content for caching or pseudo-multicasting, or to use a certain set of specialized processes, as that is predicted, or historically confirmed.

As such, the intelligent networking processes covered include efficient content distribution through the baseline of least-cost, best-performance routing, but also through caching, pseudo multi-casting, process specializations, network coding, advantaged re-combining, context-based optimization, and other techniques that boost device and system performance, but generally intend to cover optimization by streamlining access to, and use of, the collective set of links of the EDVs' in NearClouds through a unified service delivery architecture.

### Resident Method—Vertical Service on MultiPass Platform

In one embodiment, a resident method may be used, in the form of an application or hardware, or otherwise implemented as an instruction set for otherwise embedded resources, at an EDV and or in-network node. Such implementation allows any such implemented EDV or in-network node to execute the parameters described herein. This implementation may be consistent with that for the MultiPass platform. Further, when implemented as a vertical service on the MultiPass platform, other third-parties may design algorithms and methods to further optimize the delivery of content using NearClouds.

### Additional Intelligent Networking Processes Through Signal Processing

Other intelligent networking processes that use a combination of links and resources of EDVs within the unified service delivery architecture relate to multi-nodal signal processing, synchronization, and optimal combining.

In the case of network access point techniques, an EDV may transmit a signal to multiple network access points synchronously, or co-channel, and then copies of such signal may be combined at some network access point where such combination may take place, by having the multiple network access points that received the native signal synchronously, or co-channel, route the copies of such native signal to such combination point. This may relate to multiple network access points of the same wireless providers being directed to receive such signals synchronously, or co-channel and then have such signals be combined at a designated network access point or media gateway. This may be useful when a device is located more or less equidistantly from multiple network access points, and whose signal, using a specific set of frequencies, may otherwise create interference, and be interfered with, if one such network access point was to serve such device using such specific set of frequencies, while another attempted to use such specific set of frequencies for a different device (i.e. in the case of an N=1 re-use plan).

This enhancement may also be implemented across different wireless providers, similarly synchronizing to the same signal. Further, this technique may be applied to other network access point scenarios, including network access points accessed via short-range links (i.e. Wi-Fi points). The same process may also be reversed for the network access point to device transmissions, where multiple EDVs within a NearCloud, receive the same signal synchronously, or co-channel, to each other, from a network access point, and then relay the copies of the signal to the destination EDV via short-range links for combination. For example, a data transmission is relayed to a destination device and to a relay device from a network access point, using the same signal synchronously, or co-channel, but at a 2× higher coding rate than normally decipherable. The relay device forwards the data transmission to the destination device using a short-range link. The two data transmissions are combined at the destination device to produce an equivalent of a sufficiently strong signal in order for the data transmission to be decipherable.

Multiple network access points may be configured to transmit signals to a device synchronously, where copies of the signals are combined at an EDV, and where an EDV relays to multiple EDVs in a NearCloud a data segment that is in turn transmitted by each of such EDVs to a network access point via synchronous, or co-channel, signals to each other, for the combination of the copies of such signals at such network access point or some other network point.

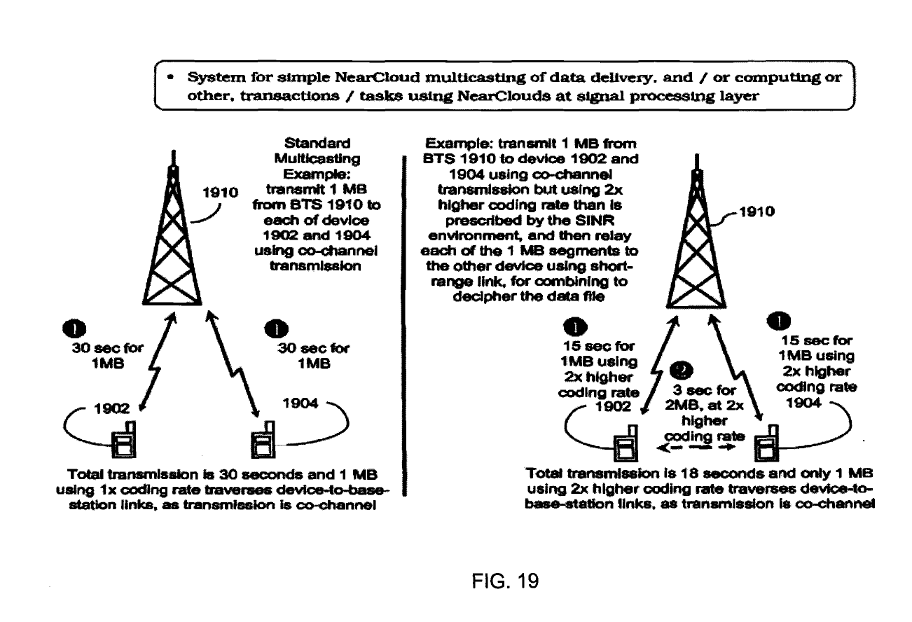

FIG. 19 shows a system for simple NearCloud multicasting of data using Nearclouds at the signal processing layer. The system may include a BTS 1710 and a plurality of EDVs (1902, 1904). In NearCloud multicasting the actual signals are delivered synchronously, or co-channel, from a given network access point to a set of EDVs in a NearCloud. Copies of the signals are relayed for re-assembly at each device. A signal is modulated at a higher coding rate than an SINR environment supports. Alternatively its EIRP is reduced from the EIRP that is required, proportionate to the number of devices or network access points that are receiving each such signal synchronously, or co-channel. The signal is then re-forwarded by each device to other devices using short-range links. The signals are then combined at the devices for an effective signal and EIRP density that is commensurate with the requirement.

Further, such intelligent network techniques may further use pure combinations (i.e. increase in signal quality from straight summation) and from other enhancements inclusive of intelligent combining to use signal diversity (polarization, phase, other orthogonal factors) and environment diversity (fading, attenuation, etc.) that exists between the multiple network access point links and the multiple EDV links. Such techniques replicate many of the currently identified networking methods directed for a dedicated wireless link, inclusive of MIMO and intelligent combining, has been the norm of operation in the past, but across the NearCloud and the unified service delivery architecture, where multiple devices and network access points may link to each other directly, use their collective links, and execute the same processes, building on what one device may have performed communicating with one network access point and using such device's (or network's) embedded resources only.

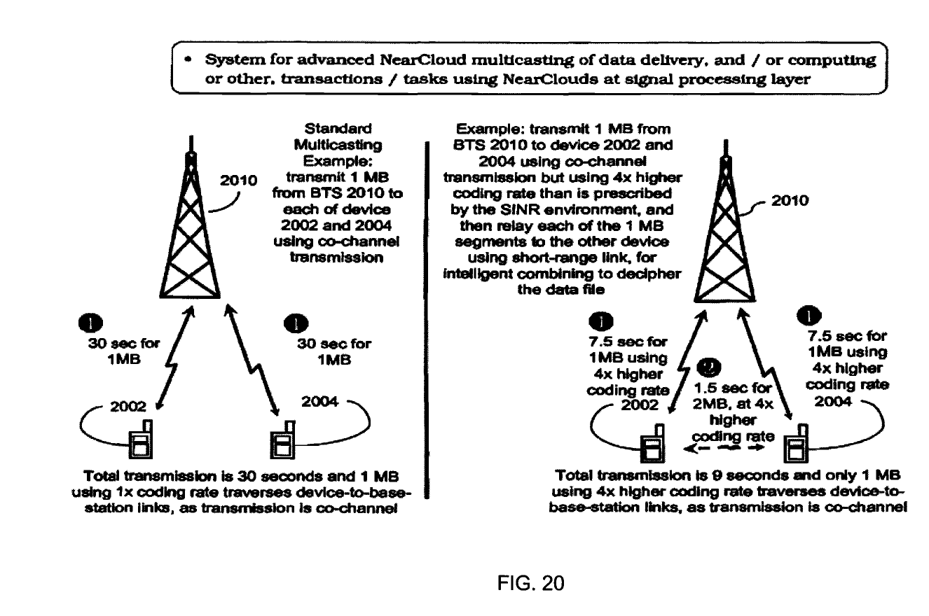

FIG. 20 shows a system for advanced NearCloud multicasting of data using Nearclouds at the signal processing layer. The system may include a BTS 2010 and a plurality of EDVs (2002, 2004).

Lastly network configurations for wireless RANs may be designed to optimally take advantage of the intelligent networking processes, including by artificial shifting the radio resource managers to use certain advantageous types of modulation coding and other techniques within the RAN for transmissions having a disclosed embodiment enabled versus otherwise, by taking advantages of the cross-carrier and cross-radio signal environment differences, in addition to cross-antenna advantages in uncorrelated fading and to the intra-carrier differences, for intelligent combining, and by load balancing the wireless network RANs.

A Multipass Spot portable apparatus is capable of being used as a portable hotspot, allowing communication with standard portable devices (PDs) not normally equipped with the complete range of wide-area wireless capabilities. PDs may include cell phones, portable computers and ultra mobile personal computers (UMPCs), multimedia and music portable devices, and radios on the consumer side. Other PDs may include portable information pads used for delivery services, portable credit card scanners, and asset tracking tools.

Because the portable apparatus is designed for portability, it typically may have a smaller form factor than non-portable relay devices and optionally may be embedded within transportation vehicles (including automobiles, trucks, or trains).

The portable apparatus is capable of simplify communications by integrating multiple wide-area communications and allowing access to the wide-area communications via short-range communications. PDs communicate using low-cost, short-range communications to the portable apparatus, but have access to wide-area communications networks via the portable apparatus, even if the PD does not have wide-area communications network capabilities.

In one embodiment, the portable apparatus has a limited user interface to facilitate a small form factor. Alternately, the portable apparatus has a user interface similar to other portable devices or computers.

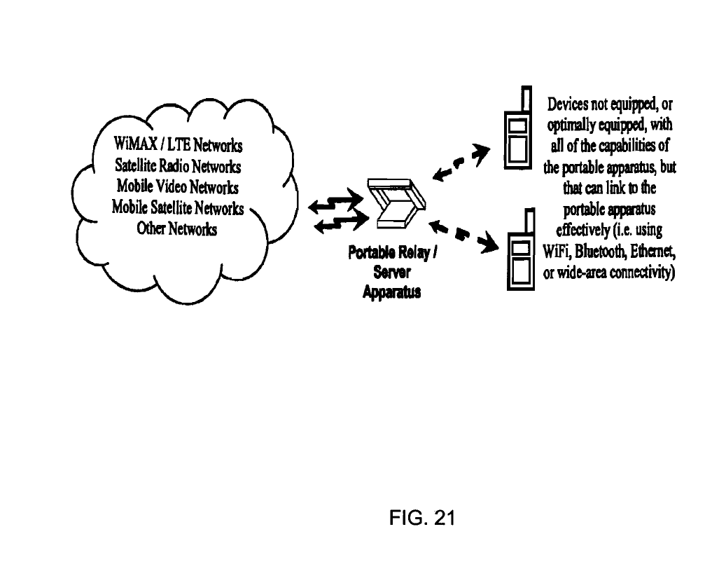

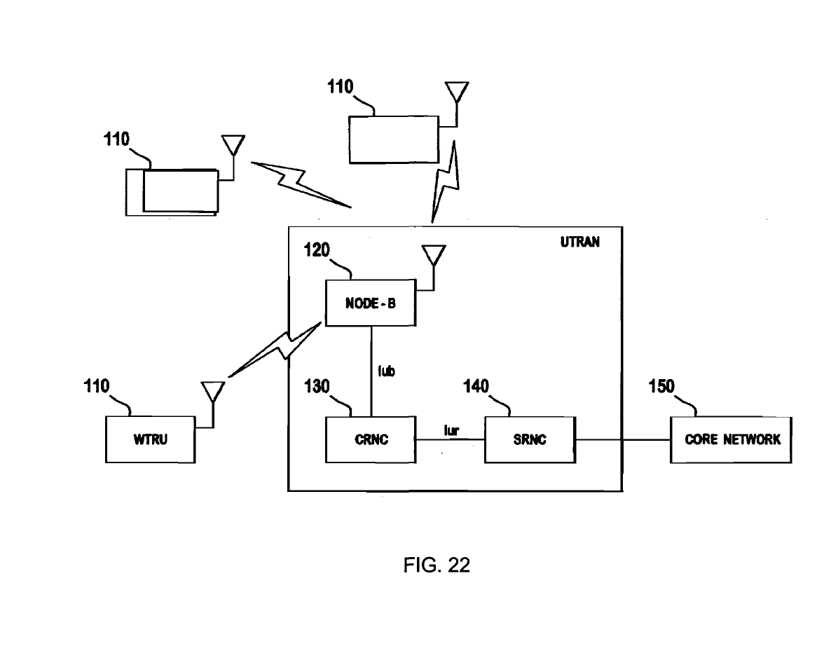

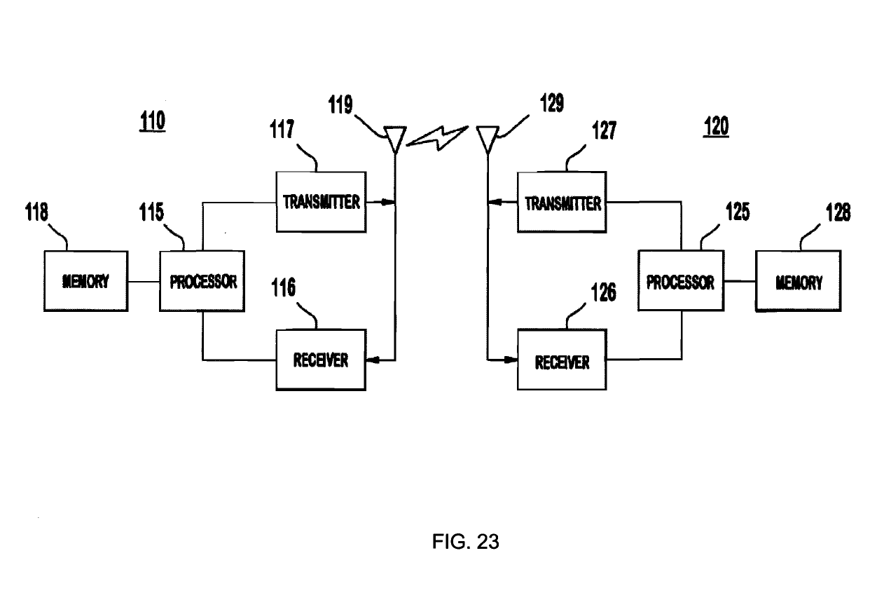

FIG. 21 shows a system employing the portable apparatus. The portable apparatus comprises a package with RF transceivers capable of receiving and transmitting using wide-area communications (e.g. radio, RF, controller, Radio Frequency Integrated Circuits (RFIC), and baseband). The portable apparatus also comprises RF transceivers capable of receiving and transmitting using short-range wireless communications, and other RF transceivers capable of communicating using wired communications. Each such radio may be capable of receiving and transmitting more than one session and form of communication, within its segment, at the same time (wide-area wireless, short-range wireless, wired). Further, such radios may be integrated into a single radio platform and may be capable of simultaneously receiving and transmitting more than one segment of sessions and form of communication at the same time, as separate radios or as a single radio platform. Such radios are to be interfaced together via common network transmission controllers and interface software within this portable apparatus package.

In an embodiment, the software of the portable apparatus is capable of running various applications. These applications are accessible by the PDs, which allows the PDs to access applications not stored on the PDs themselves or reduce the processing required by the PDs by allowing the portable apparatus to perform the associated processing. The portable apparatus, in an embodiment, is configured to utilize the NearVerse transport protocol. As a result, the portable apparatus is configured to be utilized as a component for a path for a stream for a PD. Additionally, the portable apparatus can perform caching of data for a stream to facilitate pseudo multicasting for a NearVerse system. In another embodiment, the portable apparatus is configured to operate as a proxy for the PDs.

The portable apparatus may interface to the PD via interface software that is installed on the PD. Such software may be downloaded to the PD directly from the portable apparatus, installed on the PD at the point of sale, or downloaded to the PD per instruction from the Internet. In an embodiment, the software allows the end-user to interface select applications on stored on the portable apparatus or the NearVerse transport protocol. In a predetermined mode, the portable apparatus may offer the PDs via software stored on the PDs to direct the portable device to execute desired wide-area communications functions or other capabilities for the benefit of the PD, and then relay them to the PD via short-range wireless. The software may further facilitate intelligent software-handover, allowing the end-user to use the portable apparatus for select applications and functionality, while automatically switching to the other communication capabilities, previously embedded within the consumer-facing device, for the other functionalities.

The portable apparatus may also include memory, power supply, processing, and RF capabilities, and other electronics components that are all interfaced with the transmission capabilities described herein and that enable productive use of PDs. The portable apparatus may comprise extended memory including using Flash and other memory components, and communication information may be transmitted to, and received from, the memory unit, and the portable apparatus may also serve as a portable network attached storage or server to PDs.

FIG. 22 shows a wireless communication system 2200 including a plurality of EDVs 110, a Node-B 120, a controlling radio network controller (CRNC) 130, a serving radio network controller (SRNC) 140, and a core network 150. The Node-B 120 and the CRNC 130 may collectively be referred to as the UTRAN.

As shown in FIG. 1, the EDVs 110 are in communication with the Node-B 120, which is in communication with the CRNC 130 and the SRNC 140. Although three EDVs 110, one Node-B 120, one CRNC 130, and one SRNC 140 are shown in FIG. 22, it should be noted that any combination of wireless and wired devices may be included in the wireless communication system 100.

FIG. 23 is a functional block diagram 2300 of a EDV 110 and the Node-B 120 of the wireless communication system 100 of FIG. 22. As shown in FIG. 2, the EDV 110 is in communication with the Node-B 120 and both are configured to perform any of the methods described herein.

In addition to the components that may be found in a typical EDV, the EDV 110 includes a processor 115, a receiver 116, a transmitter 117, a memory 118 and an antenna 119. The memory 118 is provided to store software including operating system, application, etc. The processor 115 is provided to perform, alone or in association with the software, any of the methods described herein. The receiver 116 and the transmitter 117 are in communication with the processor 115. The antenna 119 is in communication with both the receiver 116 and the transmitter 117 to facilitate the transmission and reception of wireless data.

In addition to the components that may be found in a typical Node-B, the Node-B 120 includes a processor 125, a receiver 126, a transmitter 127, a memory 128 and an antenna 129. The processor 125 is configured to perform any of the methods described herein. The receiver 126 and the transmitter 127 are in communication with the processor 125. The antenna 129 is in communication with both the receiver 126 and the transmitter 127 to facilitate the transmission and reception of wireless data.

### Embodiments

1. A method comprising establishing a communication network between a plurality of wireless devices.

2. The method of embodiment 1 wherein the communication network includes devices equipped for wide-area connectivity.

3. The method of embodiment 1 wherein the communication network includes non-wireless devices.

4. The method of embodiment 1 wherein the communication network includes short-range wireless devices that are not enabled for wide-area connectivity.

5. The method as in any preceding embodiment wherein each of the wireless devices establishes a communication link to another wireless device in the communication network.

6. The method of embodiment 5 wherein the devices establish communication links between each other using short-range wireless connectivity.

7. The method as in any preceding embodiment wherein at least two of the communication links between the wireless devices of the communication network use a different radio technology.

8. The method as in any preceding embodiment wherein one of the wireless devices of the network uses a resource of another wireless device of the network.

9. The method of embodiment 6 wherein the resource is at least one of a wide-area communication link, a short-range communication link, a wired communication link, a radio technology, service, an application, computation processing, location service, storage, peripheral, function, communication capability, battery/energy resource, GPS, accelerometer, environmental indicators or content.

10. The method of embodiment 8 or 9 wherein the resource of another wireless device is not a resource that is embedded and available to such wireless device within its device structure, but is instead an acquired resource.

11. The method as in any preceding embodiment wherein computing of, communication of, storage of, or any other manipulation of, application, process, service, content, or any other data or digital transaction (collectively as “digital items”) is distributed to a plurality of devices of the network.

12. The method of embodiment 11 wherein different portions of the digital items are sent to different devices of the network via short-range wireless connectivity between such devices.

13. The method of embodiment 11 wherein different portions of the digital items are sent to the different devices of the network via wide-area wireless connectivity between such devices and wireless base stations or access points (each a wireless “network node”).

14. The method as in any preceding embodiment wherein such portions of the digital items are processed, further communicated, or manipulated (“transacted”) by the different devices.

15. The method of embodiment 14 where such portions are transacted by the different devices in parallel to each other.

16. The method as in any preceding embodiment wherein results of the transaction of such portions of the digital items are assembled by a single device of the network or some other network node.

17. The method of embodiment 16 wherein such portions are assembled using short-range wireless connectivity between such devices.

18. The method of embodiment 16 wherein such portions are assembled using wide-area wireless connectivity between the different devices and the wireless network nodes.

19. The method as in any preceding embodiment wherein the different portions are assigned priorities.

20. The method as in any preceding embodiment wherein the priorities are used to optimize the transaction or the manipulation of the digital items.

21. The method as in any preceding embodiment wherein a protocol for the communication network is provided by a least one of hardware, software, firmware, applet, application or plug-in.

22. The method as in any preceding embodiment wherein control of the use of the communication links between devices is administered.

23. The method as in any one of embodiments 1-22 wherein control of communication links between devices is controlled by each device.

24. The method as in any one of embodiments 1-22 wherein control of communication links between devices is controlled by a single device.

25. The method as in any one of embodiments 1-22 wherein control of communication links between devices is distributed between devices.

26. The method as in any one of embodiments 1-22 wherein control of communication links is performed by a server.

27. The method as in any preceding embodiment wherein the communication network uses a virtual private network protocol.

28. The method as in any preceding embodiment wherein control of communication links is performed to optimize use of communication routes to execute the transaction or manipulation of the specific digital items.

29. The method as in any preceding embodiment wherein control of communication links is performed to optimize interactions between devices.

30. The method as in any preceding embodiment wherein control of communication links is performed using at least one of an application, an application suite or hardware.

31. The method as in any preceding embodiment wherein managing the network uses peer-to-peer communications between devices.

32. The method as in any preceding embodiment wherein usage of a device by another device in the network is controlled by an administration function.

33. The method as in any preceding embodiment wherein usage of a device by another device in the network is controlled by a user input to the device.

34. The method as in any preceding embodiment wherein usage of a device's resources by another device is limited to a portion of the resources.

35. The method as in any preceding embodiment wherein usage of a device's resources by another device is limited to select time intervals.

36. The method as in any preceding embodiment wherein usage of a device's resources by another device is limited to select transactions of a digital item.

37. The method as in any preceding embodiment wherein usage of a device's resources by another device is limited based on the state of the device.

38. The method as in any preceding embodiment wherein usage of a device's resources by another device is limited based on whether the device is in a passive or active state.

39. The method as in any preceding embodiment wherein usage of a device's resources by another device is limited based on predetermined criteria.

40. The method as in any preceding embodiment wherein usage of a device's resources by another device is limited based on at least one of battery life, power supply, processing/computing availability, communication link availability, or availability, or state of, any other digital item.

41. The method as in any preceding embodiment wherein usage of a device's resource or digital item by another device is limited to a portion of such resource or digital item.

42. The method as in any preceding embodiment wherein usage of a device's resource by another device is limited based on the relationship between the devices or by some other classification of such device or such another device.

43. The method as in any preceding embodiment wherein the relationship between the devices is at least one of common group, social network, company, user defined, administer defined, or defined in this Agreement or by a third party.

44. The method as in any preceding embodiment wherein usage of a device's resource by another device is limited based on the reliability of the device in executing a transaction.

45. The method as in any preceding embodiment wherein registration of a device into the communication network is automatic and prior to a data transaction.

46. The method as in any preceding embodiment wherein registration of a device into the communication network is carried out in response to a request for a transaction.

47. The method as in any preceding embodiment wherein registration of a device into the communication network uses pre-registration.

48. The method as in any preceding embodiment wherein pre-registration allows the device to carry out the remainder of registration in an expedited manner.

49. The method as in any preceding embodiment wherein registration of a device into the communication network is multi-tiered.

50. The method as in any preceding embodiment wherein registration is performed using an automatic registration followed by an authentication procedure.

51. The method as in any preceding embodiment wherein a device in the network operates as a routing or relay device.

52. The method as in any preceding embodiment wherein a device in the network operates as an end point device.

53. The method as in any preceding embodiment wherein the communication network uses security.

54. The method as in any preceding embodiment wherein the communication network uses encryption keys.

55. The method as in any preceding embodiment wherein resources of devices of the network are determined.

56. The method as in any preceding embodiment wherein a device of the communication network includes an interface to its resources.

57. The method as in any preceding embodiment wherein a clearinghouse function is performed by the communication network.

58. The method as in any preceding embodiment wherein the communication network tracks transactions between devices.

59. The method as in any preceding embodiment wherein the communication network reconciles transactions between devices.

60. The method as in any preceding embodiment wherein the communication network reimburses devices and other utilized assets for the contribution of their device/asset resources.

61. The method as in any preceding embodiment wherein resources are exchanged using credits and debits.

62. The method as in any preceding embodiment wherein access to certain devices of the communication network is not permitted.

63. The method as in any preceding embodiment wherein multiple devices access a single device.

64. The method as in any preceding embodiment wherein a single device accesses multiple devices.

65. The method as in any preceding embodiment wherein multiple devices access multiple devices.

66. The method as in any preceding embodiment wherein multiple devices access the same resource of another device.

67. The method of embodiment 66 wherein access to the same resource is through a queue.

68. The method of embodiment 66 or 67 wherein the multiple devices access the same resource sequentially.

69. The method of embodiment 66 or 67 wherein the multiple devices access the same resource in parallel.

70. The method as in any preceding embodiment wherein the transaction is performed by multiple devices in sequence.

71. The method as in any preceding embodiment wherein the transaction is performed by multiple devices in parallel, on a distributed basis between multiple devices.

72. A method as in any preceding embodiment further comprising a priority rating for any given device based on their ability to carry out the directed action.

73. A method as in any preceding embodiment further comprising creating a virtual device wherein a portion is public and another portion is private.

74. A method as in any preceding embodiment wherein the public portion of a device's resources is accessible the communication network described herein and is shared among other proximate devices' users.

75. A method as in any preceding embodiment wherein the private portion of a device's resources are not shared.

76. The method as in any preceding embodiment wherein the pubic portion of a of a device's resources is used by such device's applications in parallel to their use of the private portion.

77. The method as in any preceding embodiment wherein the public portion of a device's resources is used by such device's applications as an integrated extension of the private portion.

78. A method as in any preceding embodiment further comprising mapping a unique load to a network of Multipass devices.

79. The method as in any preceding embodiment further comprising creating Virtual Resource Operating System (VROS).

80. The method as in any preceding embodiment further comprising creating vertical services to leverage the VROS.

81. The method as in any preceding embodiment further comprising performing a transaction or a task using the VROS.

82. A vertical service configured to implement any of the preceding embodiments.

83. The method as in any preceding embodiment wherein the processing is performed for a multi-player game.

84. The method as in any preceding embodiment wherein the communication network is utilized to perform a transaction that could not have been performed by a single device, using the resources that would have been otherwise available to it absent the communication network described herein.

85. The method as in any preceding embodiment wherein communication links utilize at least one of 4G, WiMax, LTE, 3G, HSPA, HSDPA, HSUPA, WCDMA, EVDO, EDGE, GPRS, GSM, CDMA1X, Wi-Fi, Bluetooth, UWB, ZigBee, infrared, DSRC, NFC, IEEE 802.11, WAP, TCP/IP, UDP/IP, satellite radio, mobile satellite, wireless USB, USB, Ethernet, Cable, Fiber or DSL.

86. A method as in any preceding embodiment further comprising establishing a communication network between a plurality of communication devices including at least one with a short range interface and at least one with a wide area interface.

87. The method as in embodiment 1, wherein data is segmented at a given device.

88. The method as in any preceding embodiment wherein the segments are transmitted via short range interface to other devices in the case of uplink transactions.

89. The method as in any preceding embodiment wherein other devices transmit segments to the server via the network using their wide area interface, in parallel to some other segments being transmitted directly to the server via the network by the device at which the data was segmented using its wide area interface.

90. The method as in embodiment 86, wherein data is segmented at a server.

91. The method as in any preceding embodiment wherein the segments are transmitted via the network and the wide area interface to the plurality of devices in the case of downlink transactions.

92. The method as in embodiment 91, wherein the devices that are not the final destination devices transmit the segments that were directed to them to the final destination device using the short range interface.

93. The method as in any preceding embodiment wherein multiple segments are relayed from a given device to the server using multiple resources of such given device in the case of an uplink transaction, and received from a server by a given device in the case of a downlink transaction using multiple resources of such given device.

94. The method as in any preceding embodiment wherein the segments are re-assembled and combined at a given server or at a given device.

95. The method as in any preceding embodiment further comprising accessing an optimization engine to determine an assignment schedule.

96. The method as in any preceding embodiment identifying a set of enabled communication devices.

97. The method as in any preceding embodiment further comprising collecting information regarding the attributes of the plurality of communication devices and their ability to effectively transmit data using their wide area and short range interfaces.

98. The method as in any preceding embodiment further comprising assigning a reliability factor to each of the plurality of communication devices reflecting their ability to effectively transmit data using their wide area and short range interfaces overall and in specific instances.

99. The method as in any preceding embodiment wherein the reliability factor is based on the level of mobility of a communication device.

100. The method as in any preceding embodiment further comprising determining a weighted average of mobility determinants for the reliability factor for the plurality of communication devices.

101. The method as in any preceding embodiment wherein the reliability factor is based on a signal to noise ratio (SNR).

102. The method as in any preceding embodiment wherein the reliability factor is based on a signal to interference plus noise ratio.

103. The method as in any preceding embodiment wherein the reliability factor is based on a tolerance to parallel utilization and interference.

104. The method as in any preceding embodiment wherein the reliability factor accounts for a resource cost.

105. The method as in any preceding embodiment wherein the reliability factor is adjusted based on degradation due to overhead.

106. The method as in any preceding embodiment, wherein each of the communication devices are queried for information concerning their available resources.

107. The method as in any preceding embodiment wherein data distribution among the plurality of communication devices is optimized based on the reliability factor.

108. The method as in any preceding embodiment further comprising determining an optimized transmission procedure based on the availability of resources among the plurality of communication devices.

109. The method as in any preceding embodiment wherein an optimization algorithm is used to establish an assignment schedule.

110. The method as in any preceding embodiment wherein the assignment schedule provides instructions on how to communicate with the plurality of communication devices and their respective communication with the network.

111. The method as in any preceding embodiment wherein the assignment schedule determines the resource allocation of the plurality of communication devices.

112. The method as in any preceding embodiment wherein each of the plurality of communication devices receives an assignment schedule.

113. The method as in any preceding embodiment wherein the assignment schedule accounts for flow control.

114. The method as in any preceding embodiment wherein the assignment schedule determines the interactions between the wide area interfaces and the short range interfaces.

115. The method as in any preceding embodiment further comprising receiving feedback from the plurality of communication devices and the server regarding the success of data delivery.

116. The method as in any preceding embodiment further comprising adjusting the assignment schedule based on feedback.

117. The method as in any preceding embodiment further comprising segmenting data for transmission to the plurality of communication devices.

118. The method as in any preceding embodiment wherein the data is segmented based on the assignment schedule.

119. The method as in any preceding embodiment further comprising re-assembling segmented data.

120. The method as in any preceding embodiment wherein reassembly is based on the assignment schedule.

121. The method as in any preceding embodiment wherein power control is based on the assignment schedule.

122. The method as in any preceding embodiment wherein each of the plurality of communication devices are configured to register with each other.

123. The method as in any preceding embodiment further comprising generating a master address table based on the IP address of each of the plurality of communication devices.

124. The method as in any preceding embodiment wherein segmented data is received from a first communication device and forwarded to a second communication device.

125. The method of any embodiment wherein segmented data is prioritized and transmitted according to the priority.

126. The method as in any preceding embodiment further comprising transmitting data to a non-enabled communication device.

127. The method as in any preceding embodiment further comprising determining a transmission order for the non-enabled communication device.

128. The method as in any preceding embodiment wherein communication devices that are connected to the non-enabled communication devices are classified as egress or ingress nodes.

129. The method as in any preceding embodiment wherein data segments are forwarded directly between enabled devices using links to their virtual IP addresses.

130. The method as in any preceding embodiment wherein data segments that are forwarded to ingress nodes, or are forwarded on from egress nodes are forwarded using links to their actual IP addresses.

131. The method as in any preceding embodiment further comprising performing error correction.

132. The method as in any preceding embodiment further comprising retransmitting lost segments.

133. The method as in any preceding embodiment wherein the lost segments are optimized for retransmission.

134. The method as in any preceding embodiment further comprising determining the location and proximity of the plurality of communication devices.

135. The method as in any preceding embodiment further comprising calculating an error rate for communication with a device.

136. The method as in any preceding embodiments further comprising adjusting an assignment schedule based on the error rate.

137. The method as in any preceding embodiment further comprising re-segmenting data that was sent in error.

138. The method as in any preceding embodiment, wherein communication with a device is performed by a first radio using the short range interface.

139. The method as in any preceding embodiment, wherein communications using the wide area interface is performed by a second radio.

140. The method as in any preceding embodiment wherein the caching and buffering at a device is determined by the assignment schedule.

141. The method as in any preceding embodiment wherein segmented data is cached and buffered at the plurality of the devices.

142. The method as in any preceding embodiment wherein segmented data is cached according to the location of a given device, according to probabilistic access to such data by a multitude of devices within a given location, and according to the prospective requirement for such data access due to some interconnected predispositions for such data access by various devices.

143. The method as in any preceding embodiment wherein the segmented data is transmitted in parallel by the plurality of communication devices.

144. The method as in any preceding embodiment further comprising communicating via pseudo-multicasting.

145. The method as in any preceding embodiment wherein a network segments content into a plurality of segments.

146. The method as in any preceding embodiment wherein the network transmits a different subset of such segments to the plurality of the different devices in parallel using wide area interface.

147 The method as in any preceding embodiment wherein the plurality of the different devices cache such different subset of such segments.

148. The method as in any preceding embodiment wherein such given devices further re-transmit such different subset of such segments to the remaining plurality of the communication devices using the short-range interfaces.

149. The method as in any preceding embodiment further comprising re-assembling the entirety of such segments into the original content at each of the plurality of the devices.

150. The method as in any preceding embodiment wherein the content is transmitted over multiple channels.

151. The method as in any preceding embodiment wherein the content is transmitted synchronously on a co-channel basis to a plurality of devices.

152. The method as in any preceding embodiment wherein the content is modulated at higher rates.

153. The method as in any preceding embodiment wherein the content is transmitted synchronously on a co-channel basis at higher modulation rates than normally sufficient.

154. The method as in any preceding embodiment wherein content is transmitted orthogonally offset from all such other content transmissions to the plurality of devices.

155. The method as in any preceding embodiment wherein orthogonally offset content is combined via short range interfaces between such devices to recover the content through coherent and incoherent combining.

156. The method as in any preceding embodiment wherein receive diversity is implemented, but using the re-combination of data segments via short-range interface between devices.

157. The method as in any preceding embodiment comprising re-segmenting previously segmented data for short range communications between given devices.

158. The method as in any preceding embodiment further comprising forwarding re-segmented data as soon as it is received.

159. The method as in any preceding embodiment further comprising identifying all resources of proximate devices.

160. The method as in any preceding embodiment further comprising determining how a transaction is best executed.

161. The method as in any preceding embodiment further comprising querying links for reliability factors.

162. The method as in any preceding embodiment further comprising generating an attribute identification table.

163. The method as in any preceding embodiment wherein the attribute identification table is based on at least one of least cost evaluation, pre-condition, and reliability factor.

164. The method as in any preceding embodiment further comprising creating an assignment schedule based on the attribute identification table.

165. The method as in any preceding embodiment further comprising receiving feedback in response to a transmission.

166. The method as in any preceding embodiment further comprising recalculating an assignment schedule based on the feedback.

167. The method as in any preceding embodiment further comprising executing a task according to the assignment schedule.

168. The method as in any preceding embodiment further comprising determining preconditions for a device.

169. The method as in any preceding embodiment wherein the preconditions include at least one of load, percentage of available resource loaded, battery power, and time frame.

170. The method as in any preceding embodiment wherein the preconditions notify other devices the extent to which they may use a resource.

171. The method as in any preceding embodiment further comprising receiving information regarding a tier of access.

172. The method as in any preceding embodiment further comprising creating a database for organizing the types of users and the tiers of access.

173. The method as in any preceding embodiment further comprising categorizing users based on a social networking application.

174. The method as in any preceding embodiment further comprising permitting access to a device based on the device's tier of access.

175. The method as in any preceding embodiment wherein data is multicast through the plurality of communication devices and copies of such multicast segments associated with each of the plurality of the devices are sent to each of the other of the plurality of the communication devices via short-range networking, and then all of such data and segment copies are re-combined at each of such devices.

176. The method as in any preceding embodiment where the network adjusts its traffic and route scheduling mechanism based on the availability of the techniques covered in such preceding embodiments.

177. The method of embodiment 176, where the network employs additional spectrum efficiency tactics including load balancing, better spectrum/power resource management, and further intelligent combining.

178. The method of any preceding embodiment wherein communication devices utilize at least one of 4G, WiMax, LTE, 3G, HSPA, HSDPA, HSUPA, WCDMA, EVDO, EDGE, GPRS, GSM, CDMA1X, Wi-Fi, Bluetooth, UWB, ZigBee, infrared, DSRC, NFC, IEEE 802.11, WAP, TCP/IP, UDP/IP, satellite, mobile satellite, wireless USB, USB, Ethernet, Cable, Fiber or DSL.

179. A system implementing the method as in any preceding embodiment.

180. A device for use in any preceding embodiment.

181. The device of embodiment 180 wherein the device is a wireless device.

182. The device of embodiment 180 wherein the device is a wired device.

183. A method as in any of the preceding embodiments further comprising creating a network of devices.

Although features and elements are described above in particular combinations, each feature or element may be used alone without the other features and elements or in various combinations with or without other features and elements. The methods or flow charts provided herein may be implemented in all devices equipped with wide-area wireless communications capabilities, including: a) capabilities to use two-way terrestrial wireless networks based on 4G air interfaces, including WiMAX and The Third Generation Partnership Project (3GPP) Long Term Evolution (LTE), on 3G air interfaces, including EV-DO and High Speed Packet Access (HSPA)/High-speed Downlink Packet Access (HSDPA)/High-speed Uplink Packet Access (HSUPA), on Second Generation (2G) air interfaces, including GPRS, Global System for Mobile communications (GSM), Enhanced Data rates for GSM Evolution (EDGE) and CDMA 1X, all of the terrestrial wireless networks' evolutions, and any other two-way networks; b) capabilities to receive one-way, forward-only (network-to-device) terrestrial wireless communications, including mobile and fixed broadcast TV, radio, and other broadcast networks transmitting information to devices; c) capabilities to use one-way, return-only (device-to-network) terrestrial wireless networks including asset tracking networks and other networks that capture input from devices; and/or d) capabilities to use satellite networks including two-way and push-to-talk voice-based mobile satellite networks, two-way and simplex data mobile satellite networks (inclusive of location-identification networks), mobile satellite radio and mobile satellite video networks, and two-way, broadcast, and simplex data fixed satellite networks. The methods or flow charts provided herein may also be implemented in all devices equipped with short-range wireless communications capabilities, including capabilities to communicate using Wi-Fi, Bluetooth, Ultra-wideband (UWB), ZigBee, infrared, Dedicated short-range communications (DSRC), and Near Field Communication (NFC) and other short-range wireless air interfaces, including all other air interfaces based on IEEE 802.11 standards, and is also further applicable to all devices equipped with wired communications capabilities, including capabilities to communicate over Universal Serial Bus (USB), Ethernet, Cable, Fiber, Digital subscriber line (DSL), and/or other wired communication mediums.

The methods or flow charts provided herein may further be implemented in a) conventional, portable consumer communication devices like mobile phones, pagers, Personal Digital Assistants (PDA's), laptops, tablet computers, smart-phones, UMPCs, and other conventional, portable consumer communication devices; b) any other consumer and/or non-consumer devices equipped with communications capabilities, including Wi-Fi and Bluetooth enabled MP3 players, video players, portable gaming consoles, home and business appliances, other electronics, electronic toys, and etc. The methods or flow charts provided herein may be implemented in network devices that in whole, or as a subset of their functionalities, may act as: a) relays in RF communication, between a core network operator, including such as a wireless or wired service provider as AT&T, and communications-EDVs, such intermediary network devices including Femtocells, WAPs, Routers, Relays, Repeaters, and all other devices configured to act as relays for at least a subset of their functionalities; and b) servers to communications-EDVs including home electronics equipment such as set-top boxes (STBs), DVD players, TVs, and etc., computers configured as servers, and all other devices configured to act as servers for at least a subset of their functionalities.

The methods or flow charts provided herein may be implemented in mobile and portable, personal devices, as they are often used in certain environments with many other proximate portable, personal devices and are frequently changing their location. At the same time, those skilled in the art will understand that the set of methods are applicable to all communication devices that are capable of communication using short-range and wide-area wireless and wired communication techniques, with additional meaningful applications for more stationary and fixed devices equally evident.

The methods or flow charts provided herein may be applicable to accessing and using the resources of EDVs, or enabled capabilities, by other EDVs, with all resources available to such devices as applicable, including but not limited to communication capabilities, computing and processing capabilities, storage capacity (memory), battery and energy resources, GPS and other location-identification apparatus, accelerometer, environment indicators, embedded or installed user applications, processes, other applications, and content, and any other resources that are embedded, or are accessible by such devices, for input, output, and/or processing, and/or that are applications and interfaces with the users of such devices, inclusive of content. As an example, an end-point EDV may access and use the processing resources of a nearby relay EDV, augmenting its own processing capability, to compute a task. Further, an end-point EDV may be directed to access and use the content that is cached at a relay EDV, as part of a data stream that such end-point EDV is downloading.

What is claimed is:

1. A wireless device comprising:
means for receiving first packets of an IP flow utilizing a wireless link to a first communication device during a first time interval, wherein the first communication device is a cellular base station or a Wi-Fi access point;
means for receiving second packets of the IP flow utilizing a peer-to-peer wireless link to a second communication wireless device during the first time interval; and
means for recovering the IP flow utilizing the first and second packets, wherein the first packets and second packets are associated with the same IP flow.

2. The wireless device of claim 1 wherein the peer-to-peer wireless link is a Bluetooth or peer-to-peer Wi-Fi link.

3. The wireless device of any one of claim 1 or 2 further comprising means for receiving third packets of the IP flow utilizing a wireless link to a third communication device during the first time interval and wherein the means for recovering the IP flow utilizes the first, second and third EP packets.

4. The wireless device of claim 3 further comprising means for caching the received first packets; and means for transmitting the received first packets to another device.

5. A method comprising:
a wireless device receiving first packets of an IP flow utilizing a wireless link to a first communication device during a first time interval, wherein the first communication device is a cellular base station or a Wi Fi access point;
the wireless device receiving second packets of the IP flow utilizing a wireless link to a second communication device during the first time interval; and
the wireless device recovering the IP flow utilizing the first and second packets, wherein the first and second packets are associated with the same IP flow.

6. The method of claim 5 wherein the wireless link to the second communication device is a Bluetooth or peer-to-peer Wi-Fi link.

7. The method of any one of claim 5 or 6 further comprising the wireless device receiving third packets of the IP flow utilizing a wireless link to a third communication device during the first time interval and wherein the recovering of the IP flow utilizes the first, second and third IP packets.

8. The method of claim 5, further comprising the wireless device caching the received first packets; and the wireless device transmitting the received first packets to another device.

9. The wireless device of claim 1, wherein the IP flow originates from a single server, and
wherein the entire IP flow is transferred to the wireless device utilizing the plurality of other wireless devices and each of the other wireless devices is not sent all the data of the IP flow.

10. (canceled)

11. The wireless device of claim 1, wherein the packets of the IP flow include a destination address of the wireless device and the first data and second data of the IP flow are TCP/IP packets having addresses of the plurality of wireless devices.

12. The wireless device of any one of claim 9, 10 or 11 further comprising means for storing a link quality associated with each of the wireless devices.

13. The wireless device of claim 12 wherein a transfer rate of the data sent to one of the plurality of wireless devices is derived from at least the stored link quality.

14. The wireless device of claim 13 further configured to transmit an acknowledgment in response to the received first data or second data, wherein the link quality of each wireless device is derived at least from acknowledgements received from the wireless device.

15-20. (canceled)

21. The wireless device of claim 1 comprising:
means for transferring data of the IP flow utilizing a plurality of wireless paths;
means for monitoring a quality of each of the plurality of wireless paths; and
means for adjusting a transfer rate of the data of the IP flow over each of the wireless paths in response to at least the monitored quality of that wireless path.

22. The wireless device of claim 21 wherein at least one of the wireless paths is to a cellular base station or Wi-Fi access point and at least one of the wireless paths is to another wireless device.

23-58. (canceled)
